(19) United States
(12) Patent Application Publication
(10) Pub. No.: US 2009/0144512 A1
(43) Pub. Date: Jun. 4, 2009

(54) MEMORY ACCESS CONTROL DEVICE, CONTROL METHOD, AND PROGRAM

(75) Inventor: Osamu Yoshida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/200,383

(22) Filed: Aug. 28, 2008

(30) Foreign Application Priority Data
Dec. 3, 2007 (JP) 2007-312038

(51) Int. Cl. G06F 12/00

(52) U.S. Cl. 711/154; 711/E12.001

(57) ABSTRACT

A data conversion unit divides data to be written to, for example, a non-volatile memory having a limited number of times of rewriting including erasure of a memory device into divided write data having a predetermined bit width and subjects each of the divided write data to conversion to conversion data in which the update frequency from bit 0 to bit 1 when incrementing or decrementing is performed is approximately equal among respective bit positions. A data reverse conversion unit decomposes the data read from the non-volatile memory into divided read data having the predetermined bit width and subjects each of the divided read data to conversion opposite to the conversion of the data conversion unit so as to return the data to the original data.

This application is a priority based on prior application No. JP 2007-312038, filed Dec. 3, 2007, in Japan.

### BACKGROUND OF THE INVENTION

1. Field of the Invention

The present invention relates to a memory access control device, memory access control method, and program of a non-volatile memory or the like having a limited number of times of rewriting and, particularly, relates to a memory access control device, control method, and program for extending the life of the memory by converting write data so as to reduce the number of times of rewriting of a memory device.

2.Description of the Related Arts

Conventionally, non-volatile memories such as EEPROMs and FLASH memories (flash ROMs) have characteristics that they retain data even when power is turned off after the data is written, and they have been used in various uses as memory means of information processing devices. For example, recently, they are used as user data memory areas of, for example, magnetic disk devices in some cases. Generally, as a characteristic of a non-volatile memory, there is a drawback that deterioration of a memory device is caused when the number of times of rewriting from bit 0 to bit 1 is increased; and, regarding reliability of reading/writing, there is a problem that writing cannot be performed more than, for example, 100,000 times. In the data retained in the non-volatile memory, the operation considered to perform rewriting most frequently is the operation of counting the number of times of some phenomena. Hereinafter, counting processing will be referred to as a counter. If a method of improving the deterioration can be provided in the case in which the non-volatile memory is used as a counter, the life of the non-volatile memory can be extended averagely. When the motion of the counter is watched, a least significant bit frequently repeats the motion of “0, 1, 0, 1 . . . ”; and, generally, the closer to upper bits, the less the rate of the change. As a method of improving the element deterioration of such a non-volatile memory having a limited number of times of rewriting, conventionally, there is a method shown in FIG. 1. The method of FIG. 1 proposes the method in which, regarding binary data having digits 111, 112, 113, 114, 115, and 116 each of which comprising 4 bits, the least significant digits 111 are extended by adding 4-bit digits 110 thereto so as to cause them to have 8 bits, and, when the value of the counter is updated, the least significant digits are changed like “00000010, 00000100, 00001000 . . . ” by making a shift by 1 bit in every update from “00000001”, thereby suppressing updates of the least significant bits (Patent Document 1). The reason for this is based on the idea that the number of times of rewriting as a counter can be reduced by making an arrangement merely about lower digits since the change of the memory cells from bit 0 to bit 1 more frequently occur in the lower digits more than in upper digits. In another method, as shown in FIG. 2, the least significant bit is decremented in a bit-inverted state in a counting operation, thereby reducing the number of times of rewriting (Patent Document 2). For example, in the count processing of FIG. 2, when lower 4 bits are viewed, an initial state is caused to be “1111” by inversion, thereafter, the least significant bit is decremented by a next counting operation in every counting operation so that they are changed to “1110”, “1101”, “1100” . . . , and rewriting from bit 0 to bit 1 is caused to occur at the bit positions shown by a hatched part, thereby reducing the number of times of rewriting by half. [Patent document 1] Japanese Patent No. 2560688 [Patent document 2] Japanese Patent Application Laid-Open Publication No. 2006-164354

However, such conventional methods of reducing the number of times of rewriting of a non-volatile memory have following problems. The method of Patent Document 1 reduces the number of times of rewriting by making a particular arrangement at a particular memory part of a non-volatile memory and has a problem that the area that can be used as a counter of the non-volatile memory is limited. The method of Patent Document 2 reduces the number of times of rewriting by half; therefore, from the viewpoint of updating the life, merely the effect that extends it by about two times is obtained, and satisfactorily improving it is difficult.

### SUMMARY OF THE INVENTION

According to the present invention, a memory access control device, memory access control method, and program which do not have any limitation imposed on the area of a memory used as a counter and are capable of satisfactorily extending the updated life of the number of times of rewriting is provided.

### (Device)

The present invention is a memory access control device comprising:

a memory having a limited number of times of rewriting;

a data conversion unit dividing data to be written to the memory into divided write data having a predetermined bit width and subjecting each of the divided write data to conversion to conversion data in which the frequency of update from bit 0 to bit 1 when incrementing or decrementing is performed is approximately equal among respective bit positions; and

a data reverse conversion unit decomposing the data read from the memory into divided read data having the predetermined bit width and subjecting each of the divided read data to conversion opposite to the conversion of the data conversion unit so as to return the data to original data.

Herein, the data conversion unit decomposes the data to be written to the memory into divided write data having a 2-bit width, 4-bit width, 5-bit width, 6-bit width, 7-bit width, or 8-bit width and subjects each of the divided write data to conversion to the conversion data in which the frequency of update from bit 0 to bit 1 when incrementing or decrementing is performed is approximately equal among respective bit positions; and

the data reverse conversion unit decomposes the data read from the memory into divided read data having the 2-bit width, 4-bit width, 5-bit width, 6-bit width, 7-bit width, or 8-bit width and subjects each of the divided read data to the conversion opposite to the conversion of the data conversion unit to return the data to the original data.

The data conversion unit converts the divided write data having 1 at all bits in binary display and having the predetermined bit width (1111 . . . 1) to data having bit 1 at an arbitrary bit position and bit 0 at all the other bit positions.

Specifically, the data conversion unit

converts a bit sequence 11 having the 2-bit width to a bit sequence 01 or 10,

converts a bit sequence 1111 having the 4-bit width to a bit sequence 0001, 0010, 0100, or 1000,

converts a bit sequence 11111 having the 5-bit width to a bit sequence 00001, 00010, 00100, 01000, or 10000,

converts a bit sequence 111111 having the 6-bit width to a bit sequence 000001, 000010, 000100, 001000, 010000, or 100000,

converts a bit sequence 1111111 having the 7-bit width to a bit sequence 0000001, 0000010, 0000100, 0001000, 0010000, 0100000, or 1000000, and

converts a bit sequence 11111111 having the 8-bit width to a bit sequence 00000001, 00000010, 00000100, 00001000, 00010000, 00100000, 01000000, or 10000000.

As a result, it can be returned to all 0 merely by changing merely 1 bit from bit 0 to bit 1 from the state of all-bit 1, which is suitable as an operation of the counter.

The data conversion unit decomposes the data to be written to the memory into the divided write data having the 2-bit width and subjects the divided write data to conversion so that

bit sequences before the conversion are 00, 01, 10, 11 and
bit sequences after the conversion are 00, 01, 11, 10; and

the data reverse conversion unit decomposes the data read from the memory into the divided read data having the 2-bit width and subjects the divided read data to reverse conversion so that bit sequences before the reverse conversion are 00, 01, 11, 10 and

bit sequences after the reverse conversion are 00, 01, 10, 11
in binary display.

The data conversion unit decomposes the data to be written to the memory into the divided write data having the 2-bit width and subjects the divided write data to conversion so that

bit sequences before the conversion are 00, 01, 10, 11 and
bit sequences after the conversion are 00, 10, 11, 01
in binary display; and

the data reverse conversion unit decomposes the data read from the memory into the divided read data having the 2-bit width and subjects the divided read data to reverse conversion so that bit sequences before the reverse conversion are 00, 10, 11, 01 and

bit sequences after the reverse conversion are 00, 01, 10, 11
in binary display.

The data conversion unit decomposes the data to be written to the memory into the divided write data having the 4-bit width and subjects the divided write data to conversion so that

bit sequences before the conversion are 0, 1, 2, 3, 4, 5, 6, 7, 8, 9, a, b, c, d, e, f and
bit sequences after the conversion are 0, 1, 5, d, 9, 8, a, b, 3, 7, f, e, c, 4, 6, 2
in hexadecimal display; and

the data reverse conversion unit decomposes the data read from the memory into the divided read data having the 2-bit width and subjects the divided read data to reverse conversion so that bit sequences before the reverse conversion are 0, 1, 5, d, 9, 8, a, b, 3, 7, f, e, c, 4, 6, 2 and bit sequences after the reverse conversion are 0, 1, 2, 3, 4, 5, 6, 7, 8, 9, a, b, c, d, e, f

in hexadecimal display.

The data conversion unit and the data reverse conversion unit may be provided in the memory.

### (Method)

The present invention is a memory access control method of a non-volatile memory having a limited number of times of rewriting, the memory access control method comprising:

a data conversion step of decomposing data to be written to the memory into divided write data having a predetermined bit width and subjecting each of the decomposed write data to conversion to conversion data in which the frequency of update from bit 0 to bit 1 when incrementing or decrementing is performed is approximately equal among respective bit positions; and

a data reverse conversion step of decomposing the data read from the memory into divided read data having the predetermined bit width and subjecting each of the divided read data to conversion opposite to the conversion of the data conversion step so as to return the data to original data.

### (Program)

The present invention is an access control program of a memory characterized by executing

a data conversion step of dividing data to be written to the non-volatile memory, which is disposed in a computer and has a limited number of times of rewriting, into divided write data having a predetermined bit width and subjecting each of the decomposed write data to conversion to conversion data in which the frequency of update from bit 0 to bit 1 when incrementing or decrementing is performed is approximately equal among respective bit positions; and

a data reverse conversion step of dividing the data read from the memory into divided read data having the predetermined bit width and subjecting each of the divided read data to conversion opposite to the conversion of the data conversion step so as to return the data to original data.

According to the present invention, for example, when data is written to a non-volatile memory, the change made upon incrementing or decrementing is subjected to data conversion so that bits are averagely changed among the respective bit positions regardless that whether it is a lower bit or an upper bit, thereby significantly reducing the number of times of rewriting from bit 0 to bit 1 and significantly extending the life of the non-volatile memory.

Moreover, since the converted data is written to the non-volatile memory, any position of the non-volatile memory can be used for the counter to extend the new life of the non-volatile memory, and reliability of the device can be readily enhanced. The above and other objects, features, and advantages of the present invention will become more apparent from the following detailed description with reference to the drawings.

### BRIEF DESCRIPTION OF THE DRAWINGS

FIG. 1 is an explanatory diagram showing a conventional method of reducing the number of times of rewriting at a lower bit part;

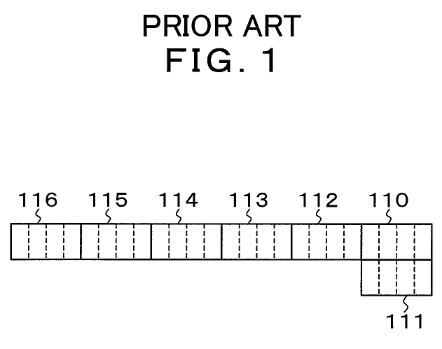

FIG. 2 is an explanatory diagram showing a conventional method of reducing the number of times of rewriting by performing decrementing after inversion.

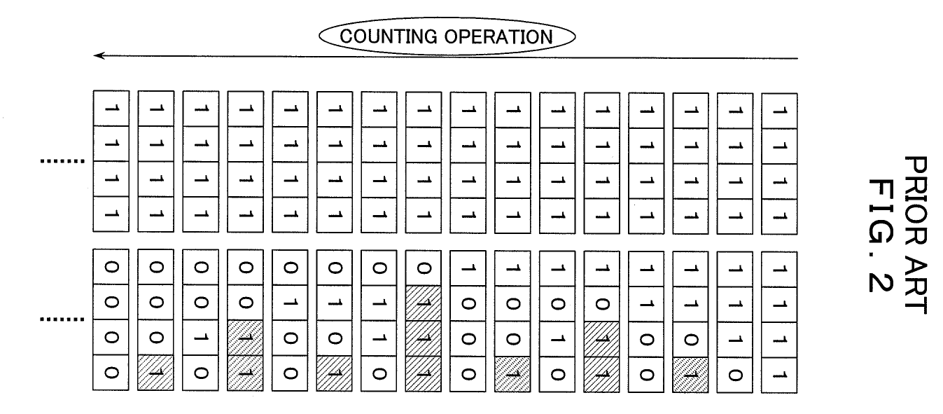

FIG. 3 is a block diagram showing an embodiment of memory access control according to the present invention for a computer;

FIG. 4 is a circuit diagram showing an embodiment of a data conversion circuit which performs processing in a 2-bit wide unit and is provided in the computer of FIG. 3;

FIGS. 5A and 5B are explanatory diagrams showing a conversion table and a reverse conversion table used in the embodiment of FIG. 4;

FIGS. 6A and 6B are explanatory diagrams showing other examples of the conversion table and the reverse conversion table used in the embodiment of FIG. 4;

FIG. 7 is a block diagram showing another embodiment in which a data conversion unit is incorporated in a non-volatile memory;

FIG. 8 is a block diagram showing another embodiment in which the function of the data conversion circuit is realized by executing a microprogram;

FIG. 9 is an explanatory diagram showing another embodiment of the data conversion circuit which performs processing in a 4-bit wide unit;

FIGS. 10A and 10B are explanatory diagrams showing a conversion table and a reverse conversion table used in the embodiment of FIG. 9;

FIGS. 11A and 11B are explanatory diagrams in which the conversion table and the reverse conversion table of FIGS. 10A and 10B are shown in hexadecimal;

FIG. 12 is an explanatory diagram showing the conversion table of FIG. 9 in an 8-bit hexadecimal display together with the numbers of times of rewriting at first to fourth bits;

FIG. 13 is a flow chart showing a procedure of generating a conversion table which can be used in the embodiment of FIG. 9;

FIG. 14 is an explanatory diagram showing 1st to 5th patterns of output data and the numbers of times of rewriting at respective bit positions of 4-bit conversion tables serving as pseudo conversion patterns extracted in step S4 of FIG. 11;

FIG. 15 is an explanatory diagram showing 1st to 5th patterns of the output data and the numbers of times of rewriting at respective bit positions of 4-bit conversion tables serving as ideal conversion patterns extracted in step S5 of FIG. 11;

FIG. 16 is an explanatory diagram showing 6th to 10th patterns subsequent to FIG. 15;

FIG. 17 is an explanatory diagram showing 11th to 15th patterns subsequent to FIG. 16;

FIG. 18 is an explanatory diagram showing 16th to 20th patterns subsequent to FIG. 17;

FIG. 19 is an explanatory diagram showing 21st to 25th patterns subsequent to FIG. 18;

FIG. 20 is an explanatory diagram showing 26th to 30th patterns subsequent to FIG. 19;

FIG. 21 is an explanatory diagram showing 31st to 35th patterns subsequent to FIG. 20;

FIG. 22 is an explanatory diagram showing 36th to 40th patterns subsequent to FIG. 21;

FIG. 23 is an explanatory diagram showing 41st to 45th patterns subsequent to FIG. 22;

FIG. 24 is an explanatory diagram showing 46th to 50th patterns subsequent to FIG. 23;

FIG. 25 is an explanatory diagram showing 51st to 55th patterns subsequent to FIG. 24;

FIG. 26 is an explanatory diagram showing 56th to 60th patterns subsequent to FIG. 25;

FIG. 27 is an explanatory diagram showing 61st to 65th patterns subsequent to FIG. 26;

FIG. 28 is an explanatory diagram showing 66th to 70th patterns subsequent to FIG. 27;

FIG. 29 is an explanatory diagram showing 71st to 75th patterns subsequent to FIG. 28;

FIG. 30 is an explanatory diagram showing 76th to 80th patterns subsequent to FIG. 29;

FIG. 31 is an explanatory diagram showing 81st to 85th patterns subsequent to FIG. 30;

FIG. 32 is an explanatory diagram showing 86th to 90th patterns subsequent to FIG. 31;

FIG. 33 is an explanatory diagram showing 91st to 96th patterns subsequent to FIG. 32;

FIG. 34 is an explanatory diagram showing, as 1st to 5th patterns, the output data used in 5-bit conversion tables of the present embodiment and the numbers of times of rewriting at respective bit positions;

FIG. 35 is an explanatory diagram showing the output data used in a 6-bit conversion table of the present embodiment and the numbers of times of rewriting at respective bit positions;

FIG. 36 is an explanatory diagram showing, as 1st to 2nd patterns, the output data used in 7-bit conversion tables of the present embodiment and the numbers of times of rewriting at respective bit positions;

FIG. 37 is an explanatory diagram showing a 3rd pattern subsequent to FIG. 36;

FIG. 38 is an explanatory diagram showing, as a 1st pattern, the output data used in an 8-bit conversion table of the present embodiment and the numbers of times of rewriting at respective bit positions;

FIG. 39 is an explanatory diagram showing a 2nd pattern subsequent to FIG. 38;

FIG. 40 is an explanatory diagram showing another embodiment of a data conversion circuit which performs processing by division in the 4-bit width and 2-bit width; and

FIG. 41 is an explanatory diagram showing a composite conversion table of FIG. 40 and a table of the numbers of times of rewriting thereof.

### DETAILED DESCRIPTION OF THE PREFERRED EMBODIMENTS

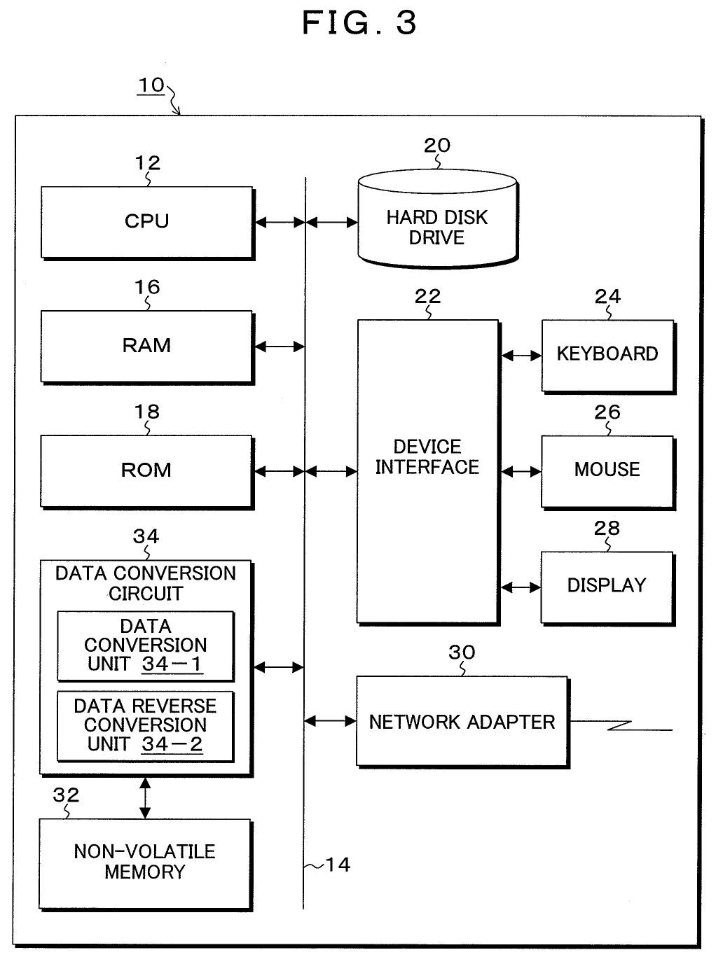

FIG. 3 is a block diagram showing an embodiment of memory access control according to the present invention for a computer. In FIG. 3, the computer 10 has a CPU 12; and a RAM 16; a ROM 18; a hard disk drive 20; a device interface 22 connecting a keyboard 24, a mouse 26, and a display 28; and a network adapter 30 are connected to a bus 14 of the CPU 12. Furthermore, in the present embodiment, a non-volatile memory 32 is connected to the bus 14 of the CPU 12 via a data conversion circuit 34. The non-volatile memory 32 is, for example, an EEPROM or a flash memory (FROM) and has nonvolatility of keeping data even when power is turned off after data is written; however, as writing reliability of a memory device (memory cell), the number of times of rewriting from bit 0 to bit 1 is limited to, for example, 100,000 times. Regarding such non-volatile memory 32 having a limited number of times of rewriting, the data conversion circuit 34 is newly provided in the present embodiment, and even when it is used as a counter of which number of times of rewriting with respect to the non-volatile memory 32 is the largest, the number of times of rewriting in counter processing is reduced by data conversion of the data conversion circuit 34 so that the life limited by the number of times of rewriting of the non-volatile memory 32 is extended. Specifically, a data conversion unit 34-1 and a data reverse conversion unit 34-2 are provided in the data conversion circuit 34. The data conversion unit 34-1 functions as a write data conversion unit, decomposes the data to be written to the non-volatile memory 32 into divided write data having a predetermined bit width, and converts it to the data in which the number of times of rewriting from bit 0 to bit 1 of the case in which the counter is incremented or decremented for each divided write data is approximately equal among respective bit positions. On the other hand, the data reverse conversion unit 34-2 functions as a read data conversion unit, decomposes data read from the non-volatile memory 32 into divided read data having a predetermined bit width, and performs data reverse conversion of returning it to original data by performing the conversion opposite to that of the data conversion unit 34-1 for each divided read data. The bit width for division into the divided read data in the data conversion unit 34-1 and the data reverse conversion unit 34-2 in the present embodiment supports a 2-bit width, 4-bit width, 5-bit width, 6-bit width, 7-bit width, or 8-bit width, as is elucidated in later descriptions; furthermore, an arbitrary bit width such as a 16-bit width, 32-bit width, or 64-bit width can be determined.

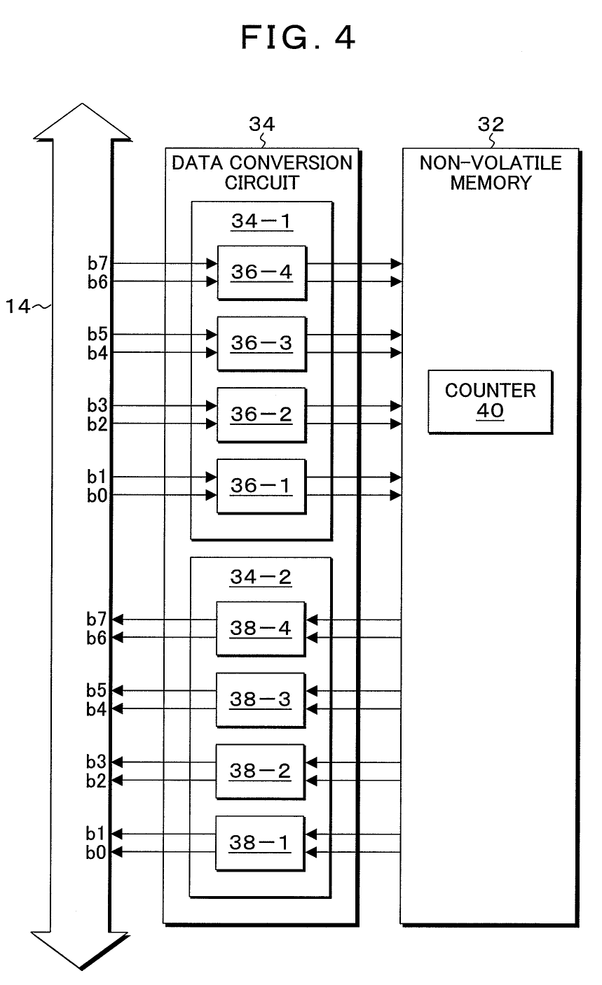

FIG. 4 is a circuit block diagram showing an embodiment of the data conversion circuit which performs processing in the 2-bit wide unit and is provided in the computer of FIG. 3. In FIG. 4, in the data conversion circuit 34 provided between the bus 14, which is from the CPU 12, and the non-volatile memory 32, the data conversion unit 34-1 and the data reverse conversion unit 34-2 are provided. In the data conversion unit 34-1, 8-bit data b0 to b7 from the bus 14 is divided in the 2-bit unit and input to 2-bit conversion tables 36-1 to 36-4, thereby performing conversions so that the number of times of rewriting from bit 0 to bit 1 of the case in which a counter 40 provided in an arbitrary area of the non-volatile memory 32 is incremented or decremented is approximately equal among respective bit positions. On the other hand, in the data reverse conversion unit 34-2, reverse conversion tables 38-1 to 38-4 for dividing the data read from the non-volatile memory 32 in the 2-bit wide unit and subjecting it to reverse conversion are provided, and the reverse conversion tables 38-1 to 38-4 perform conversions opposite to the conversions of the conversion tables 36-1 to 36-4 and output original 8-bit data b0 to b7 to the bus 14.

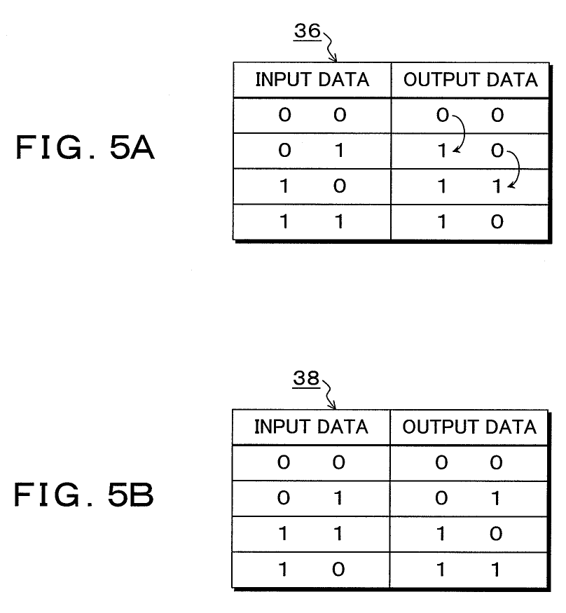

FIGS. 5A and 5B are explanatory diagrams showing the conversion table and the reverse conversion table used in the embodiment of FIG. 4. FIG. 5A shows the conversion table 36; and, in the data conversion unit 34-1 of FIG. 4, the conversion tables 36 having the same contents are used as the conversion tables 36-1 to 36-4. In the conversion table 36, 00, 01, 10, 11 having the 2-bit width is input as input data, and this is converted to output data 00, 10, 11, 10. In the 2-bit output data obtained from the conversion table 36, the number of changed times from bit 0 to 1 caused along with counter operations of a least significant bit is one as shown by an arrow, and it is one also at a second bit as shown by an arrow. On the other hand, when the counter operations are performed without performing conversion as shown in the input data, the number of changed times from bit 0 to bit 1 is two at the least significant bit. Therefore, according to the conversion table 36 of the present embodiment, the number of times of rewriting from bit 0 to bit 1 at the least significant bit can be reduced by half from two to one. The reverse conversion table 38 of FIG. 5B has the contents in which the input data and the output data of the conversion table 36 of FIG. 5A is replaced by each other and is capable of returning the 2-bit data converted in the conversion table 36 to the original 2-bit data. The conversion table 36 and the reverse conversion table 38 shown in FIGS. 5A and 5B can be realized, for example, by lookup tables (LUT) using fixed memory such as ROMs in which the output data is stored by using the input data as addresses.

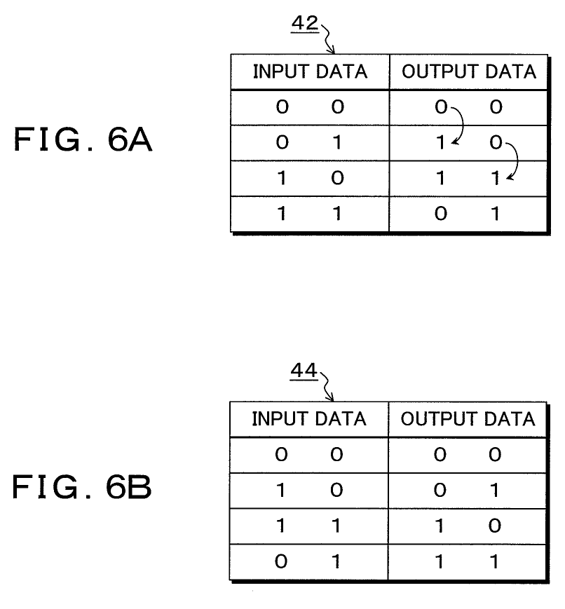

FIGS. 6A and 6B are explanatory diagrams showing other examples of the conversion table and the reverse conversion table used in the embodiment of FIG. 4. In a conversion table 42 of FIG. 6A, with respect to counting operations of 2-bit input data 00, 01, 10, 11, the output data is converted to 00, 10, 11, 01. Also in this case, the number of times of data rewriting of the least significant bit in the output data is one as shown by an arrow, and the number of times of rewriting can be reduced by half compared with two times of the case in which the conversion is not performed. FIG. 6B shows a reverse conversion table having the contents in which the input data and the output data in the conversion table 42 of FIG. 6A is replaced by each other.

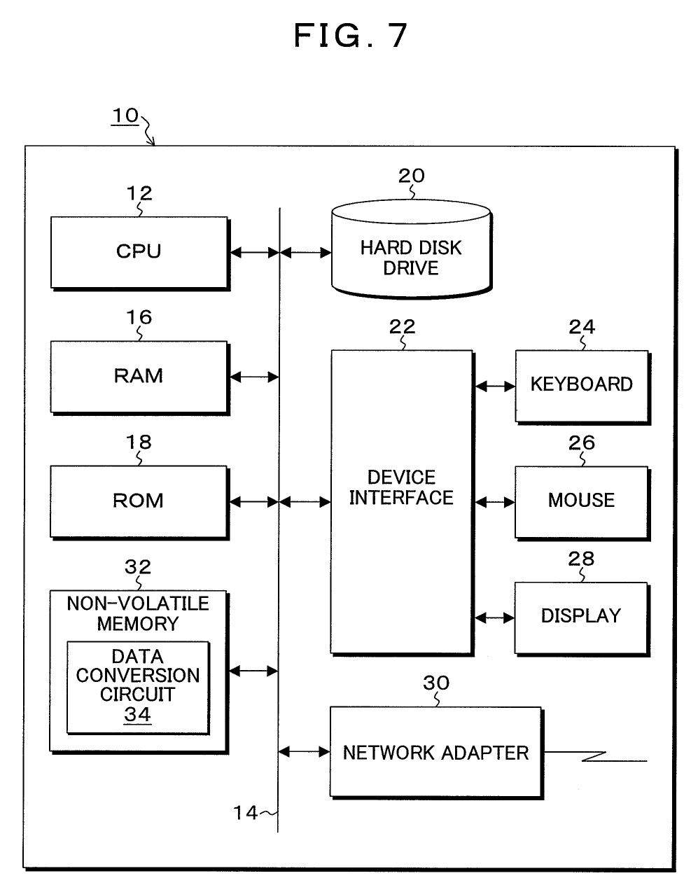

FIG. 7 is a block diagram showing another embodiment in which the data conversion circuit is incorporated in the non-volatile memory. The computer 10 of FIG. 7 is basically same as the embodiment of FIG. 3; however, the data conversion circuit 34 according to the present embodiment is incorporated in a memory device itself of the non-volatile memory 32 connected to the bus 14, and the data conversion circuit 34 has, for example, a circuit configuration same as that shown in FIG. 4.

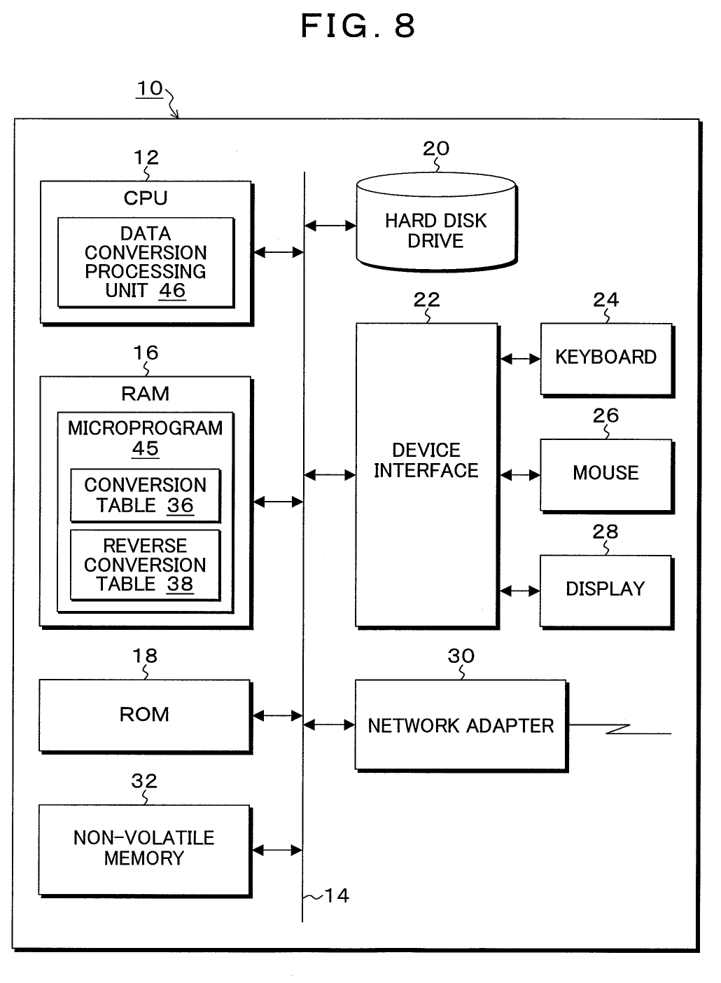

FIG. 8 is a block diagram showing another embodiment in which the function of the data conversion circuit is realized by executing a microprogram. In FIG. 8, when an OS is loaded from the hard disk drive 20 to the RAM upon activation of the computer 10, the microprogram 45 is read to and disposed in the RAM 16 as shown in the drawing by disposing the microprogram 45, which realizes the function of the data conversion circuit of the present embodiment, in the OS in advance. In the microprogram 45 deployed in the RAM 16, the conversion table 36 and the reverse conversion table 38, for example, same as those shown in FIGS. 3A and 3B are provided. The CPU 12 executes the microprogram 45 of the RAM 16, thereby realizing the function as a data conversion processing unit 46. When the memory access control unit 46 writes data to the non-volatile memory 32, the write data is converted to and written as the data in which the number of times of rewriting from bit 0 to bit 1 according to the conversion table 36 is approximately equal among the respective bit positions by using the conversion table 36. The data conversion processing unit 46 also returns the data read from the non-volatile memory 32 to the original data by using the reverse conversion table 38 and then processes it as read data.

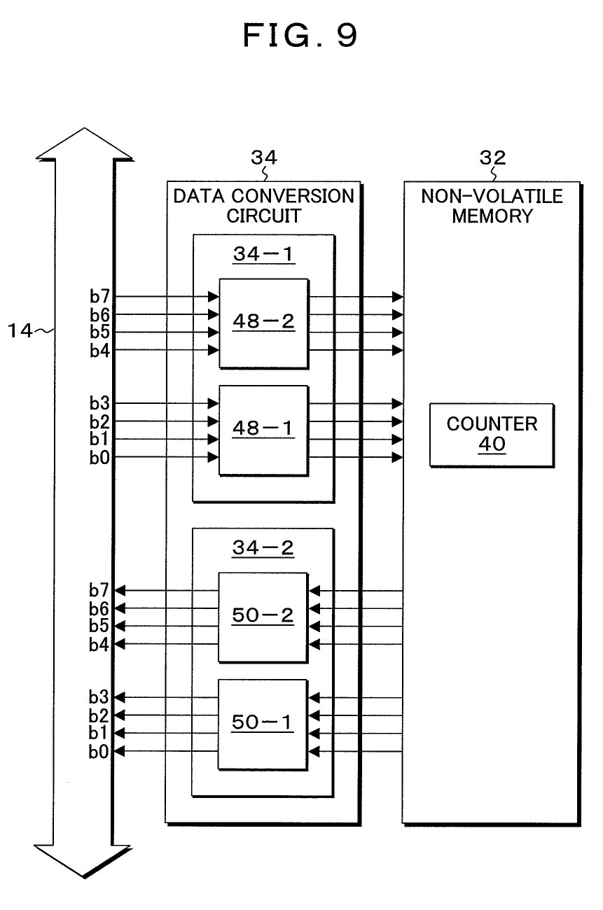

FIG. 9 is an explanatory diagram showing another embodiment of the data conversion circuit which performs processing in a 4-bit wide unit. In FIG. 9, in the data conversion circuit 34, the data conversion unit 34-1 which functions as a write data conversion unit and the data reverse conversion unit 34-2 which functions as a read data conversion unit are provided. In the data conversion unit 34-1, 4-bit conversion tables 48-1 and 48-2 are provided, and the 8-bit data b0 to b7 from the bus 14 is divided into divided write data b0 to b3 and b4 to b7 in a 4-bit unit, then converted into the data in which the number of times of rewriting from bit 0 to bit 1 is approximately equal among the respective bit positions by the 4-bit conversion tables 48-1 and 48-2 having the same conversion contents, and written to, for example, the counter 40 of the non-volatile memory 32. In the data reverse conversion unit 34-2, 4-bit reverse conversion tables 50-1 and 50-2 having the same conversion contents are provided, and the 8-bit data read from the non-volatile memory 32 is divided in the 4-bit wide unit, then is returned to the original 4-bit data by reverse conversion tables 50-1 and 50-2, and output to the bus 14 as 8-bit data combining them.

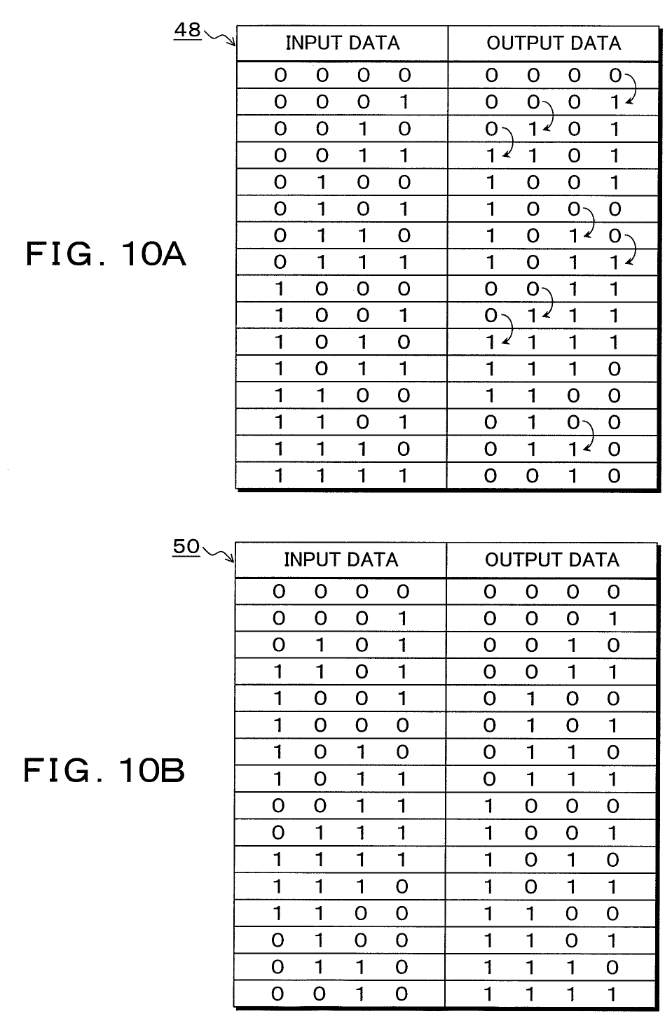

FIGS. 10A and 10B are explanatory diagrams showing the 4-bit conversion table and the 4-bit reverse conversion table used in the embodiment of FIG. 9. FIG. 10A shows the 4-bit conversion table 48, in which the 4-bit input data is subjected to data conversion so that the number of times of rewriting from bit 0 to bit 1 is approximately equal among respective bit positions. The conversion patterns of the 4-bit conversion table 48 of FIG. 10A are ideal patterns in which the number of times of rewriting that changes bit 0 to bit 1 is two at every bit position of output data as shown by arrows. Therefore, although the number of times of rewriting in the case in which the 4-bit data is subjected to counting operations without change as shown in the input data is 15 in total, specifically, eight at a first bit (least significant bit), four at a second bit, two at a third bit, and one at a fourth bit, it is eight in total in the output data according to the conversion of the present embodiment, wherein the number of times of rewriting can be reduced approximately by half.

FIG. 10B shows the 4-bit reverse conversion table 50 having the table contents in which the input data and the output data of FIG. 10A is replaced by each other.

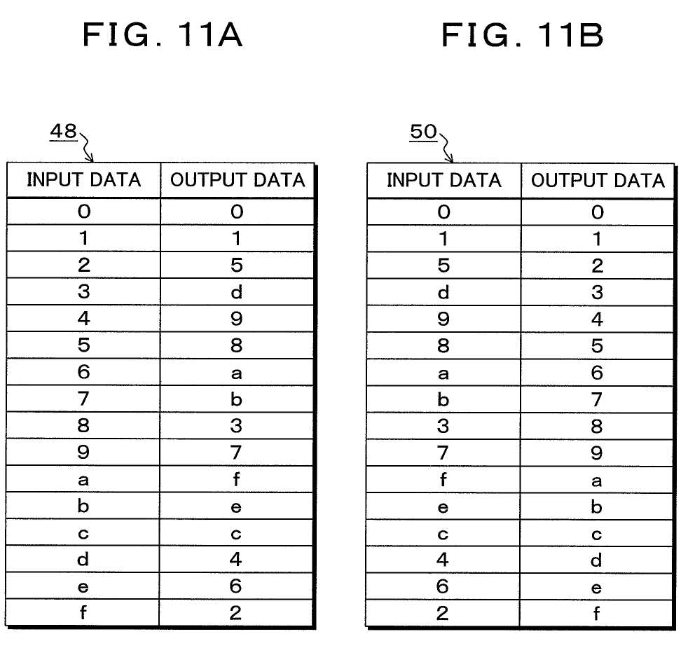

FIGS. 11A and 11B are explanatory diagrams in which the 4-bit conversion table and the 4-bit reverse conversion table of FIGS. 10A and 10B are shown in hexadecimal display.

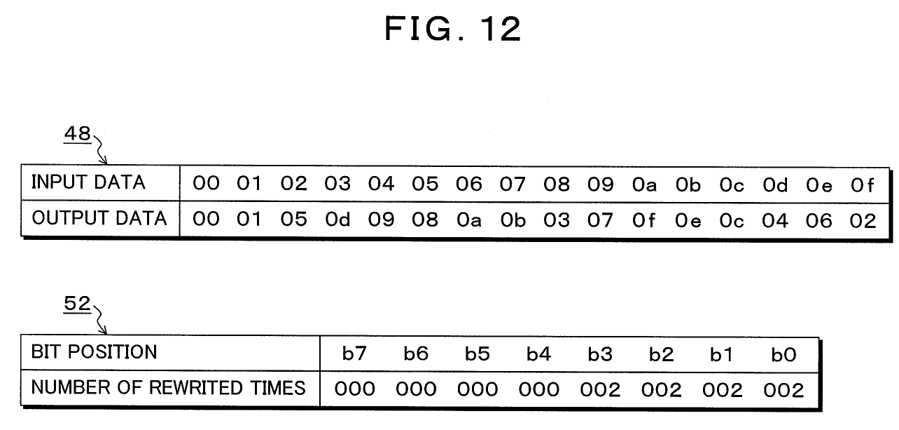

Furthermore, FIG. 12 shows the input data and the output data of the 4-bit conversion table 48 of FIG. 11A, which is shown in hexadecimal, by disposing it in a row direction and also shows, in hexadecimal, the numbers of times of rewriting with respect to respective bit positions as a table 52 of the number of times of rewriting. Note that the hexadecimal display in the 4-bit conversion table 48 of FIG. 12 is for 8-bit data (2 bytes), and every second byte representing top 4 bits is 0. In hexadecimal display, data is usually shown with “0X” attached at the top like “0x0e”; however, this is omitted in FIG. 12 for the purpose of convenience. This is also same in the hexadecimal display of FIGS. 11A and 11B. The 4-bit conversion table 48 shown in FIG. 12 has an ideal pattern in which the number of times of rewriting at every bit position of the 4 bits is two and the same; however, the present embodiment is intended to perform data conversion so that the number of times of rewriting from bit 0 to bit 1 when incremented or decremented is approximately equal among the respective bit positions; therefore, other than the pattern of the 4-bit conversion table 48 of FIG. 12, many patterns are present as 4-bit conversion tables which can be used in the present embodiment.

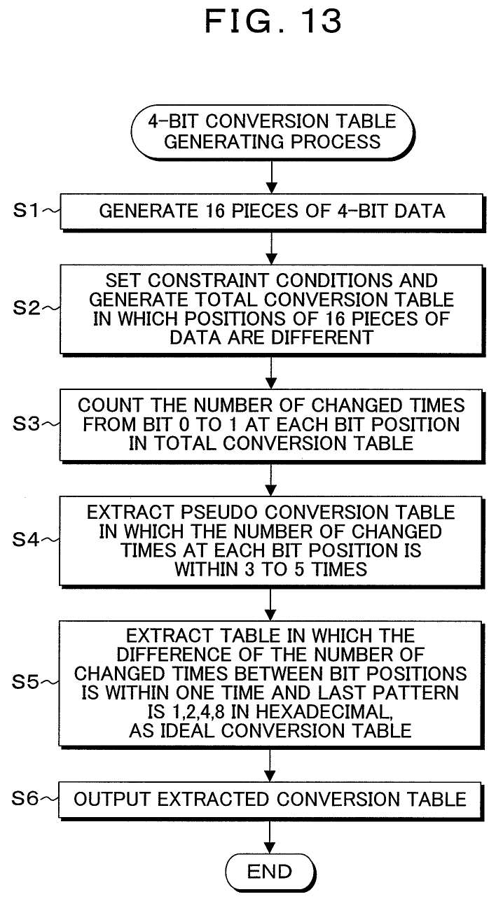

FIG. 13 is a flow chart showing a procedure of generating a 4-bit conversion table which can be used in the embodiment of FIG. 9. In FIG. 13, in a 4-bit conversion table generating process, first, 16 pieces of 4-bit data that vary from “0000” to “1111” are generated for the 4-bit data b0 to b3 in step S1. Subsequently, constraint conditions are set, and a total conversion table in which the 16 pieces of 4-bit patterns are rearranged in a counter operation direction is generated. As the constraint conditions herein, in the arrangement of the 16 types of 4-bit data, “00” and “01” is fixedly disposed in hexadecimal at the top and a second one. The reason for this is that, even if they are arranged like, for example, “00” “08” . . . , replacing all of the fourth bit positions and the first bit positions (least significant bit position) in this case results in the same thing as the case in which they begin with “00”, “01” in hexadecimal; therefore, the constraint is provided in consideration of these conditions so that they begin with “00”, “01” in hexadecimal so as to generate the patterns. Next, in step S3, the number of times of rewriting from bit 0 to bit 1 at the respective bit positions in the total conversion table is counted. Subsequently, in step S4, the patterns in which the number of times of rewriting at respective bit position is within 3 to 5 are extracted as pseudo conversion tables. The meaning of setting it as a pseudo conversion table herein is based on the fact that the conversion table generated by setting the predetermined constraint conditions in step S2 serves as an object. Furthermore, in step S5, tables in each of which the difference between the numbers of times of rewriting among the respective bit positions is within one and a last pattern is 1, 2, 4, or 8 in hexadecimal display are extracted as ideal conversion tables. Herein, the reason for extracting the tables in which the pattern of the last 4-bit data is 1, 2, 4, or 8 in hexadecimal display as the ideal conversion tables of step S5 of FIG. 13 is that, when these are displayed in binary, they are

0001
0010
0100
1000,
and they can be returned to “0000” by rewriting 1 bit in a next counting operation. The patterns of the 4-bit conversion table 48 shown in FIG. 12 can be further referred to as a most ideal optimum conversion table among the ideal conversion tables extracted in step S5. Subsequently, the process proceeds to step S6, wherein each of the pseudo conversion tables extracted in step S4 and the ideal conversion tables extracted in step S5 is output. Then, an arbitrary conversion table is selected in accordance with needs from the output conversion tables, for example the 4-bit conversion table 48 as shown in FIG. 10A and the reverse conversion table 50 as shown in FIG. 10B in which the input data and the output data is replaced by each other are generated, and they are incorporated and used in the data conversion unit 34-1 and the data reverse conversion unit 34-2 shown in FIG. 9, for example, as a ROM or the like formed as lookup tables.

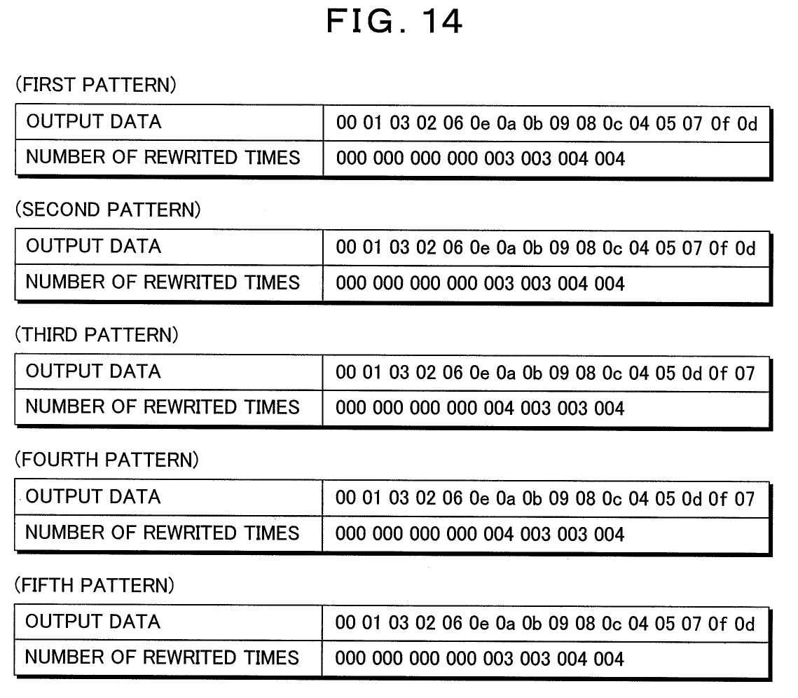

FIG. 14 shows, in a manner similar to the case of FIG. 12, the output data and the number of times rewriting of first to fifth patterns serving as part of the pseudo 4-bit conversion tables extracted in step S4 of FIG. 13. Note that, the input data of the 44-bit conversion tables is “00, 01 02 . . . 0f” in hexadecimal display as shown in FIG. 12; however, this is omitted.

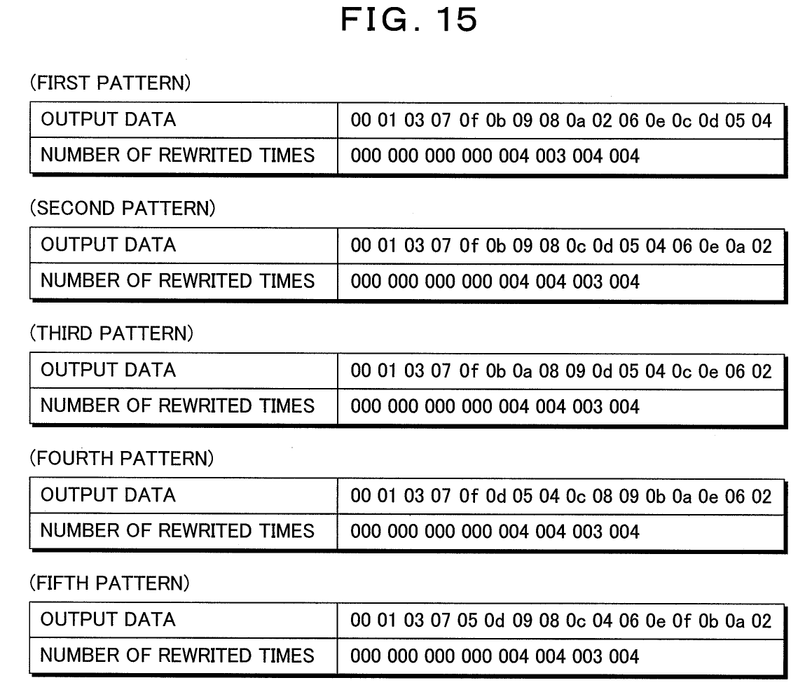

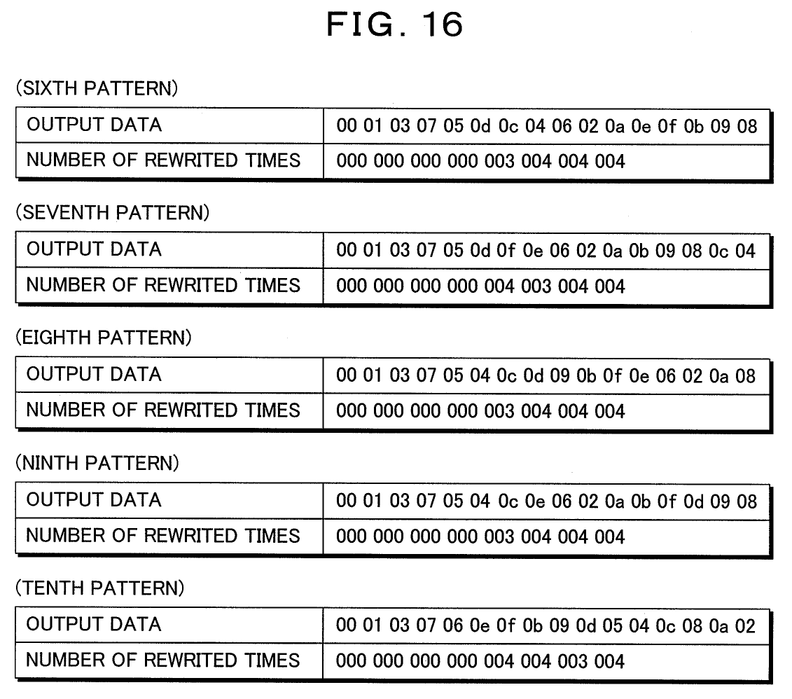

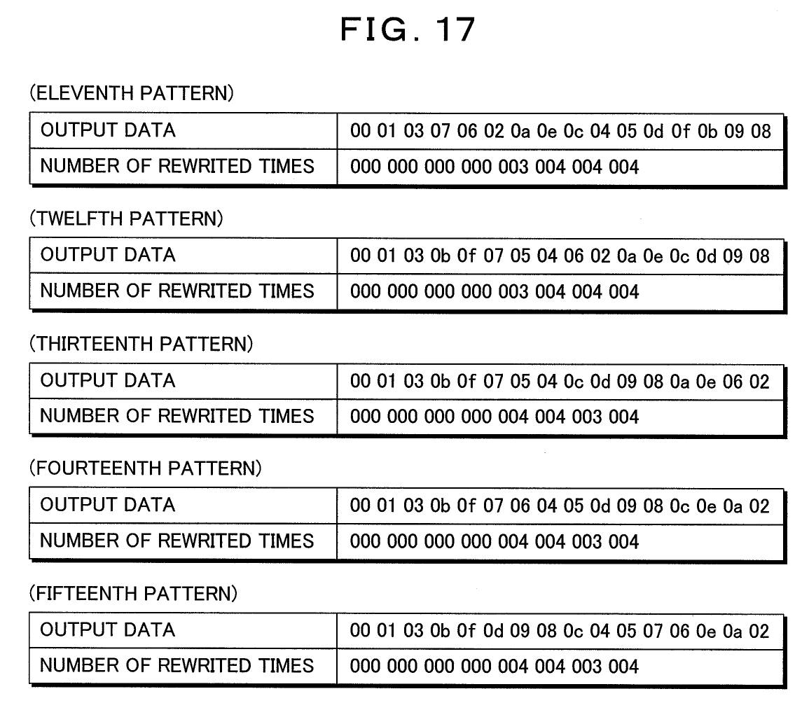

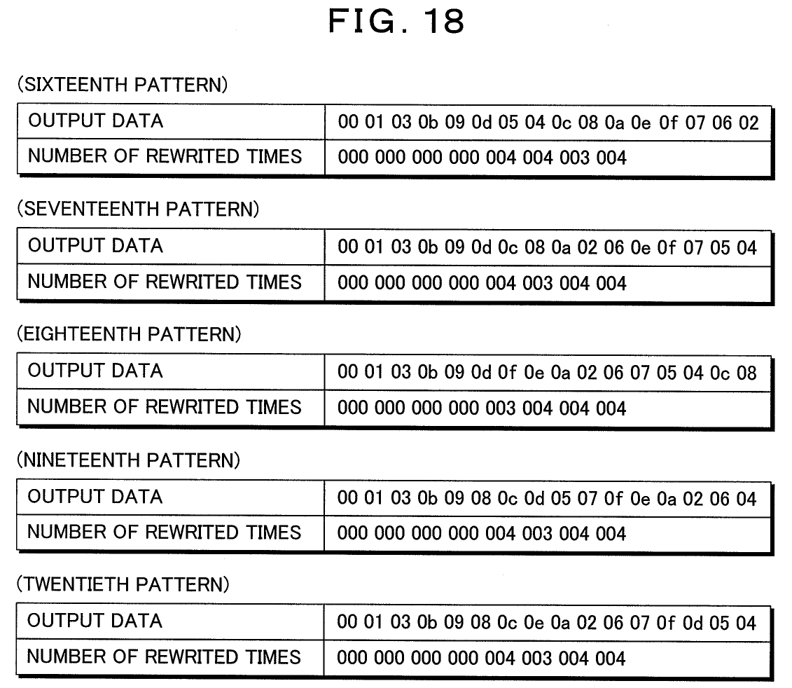

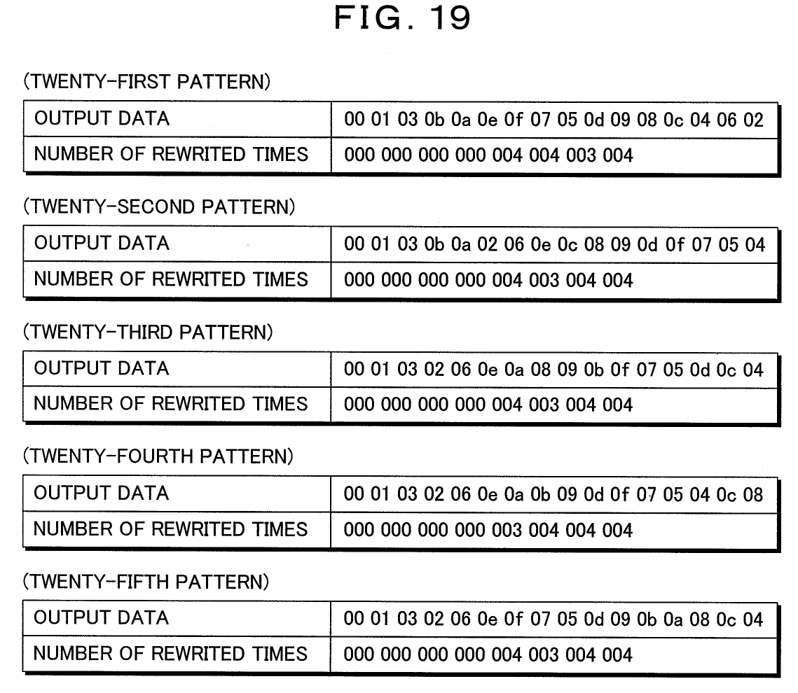

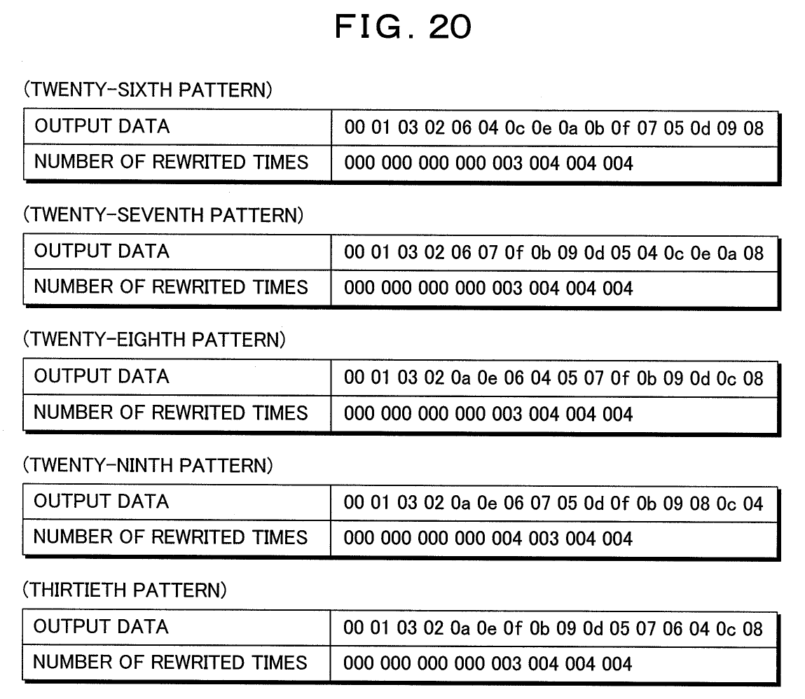

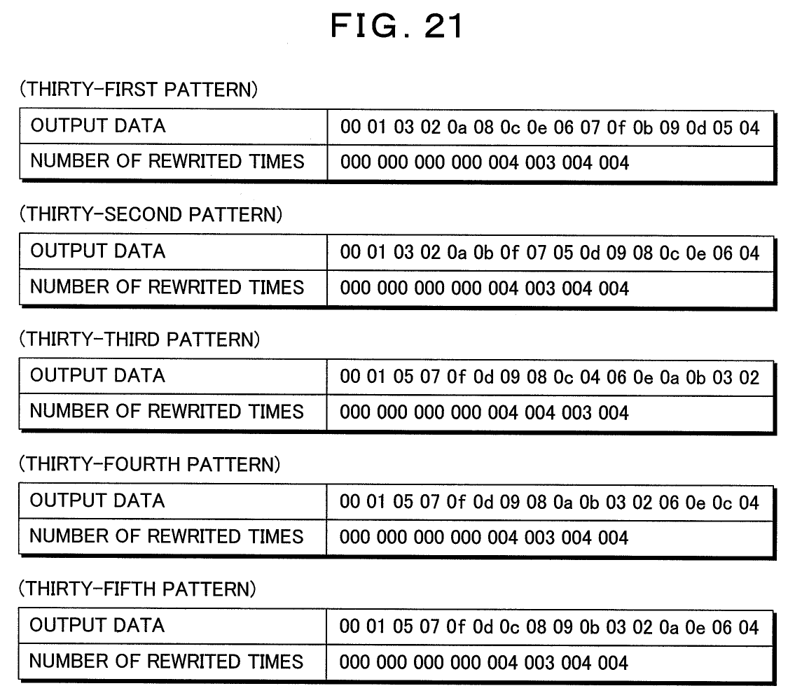

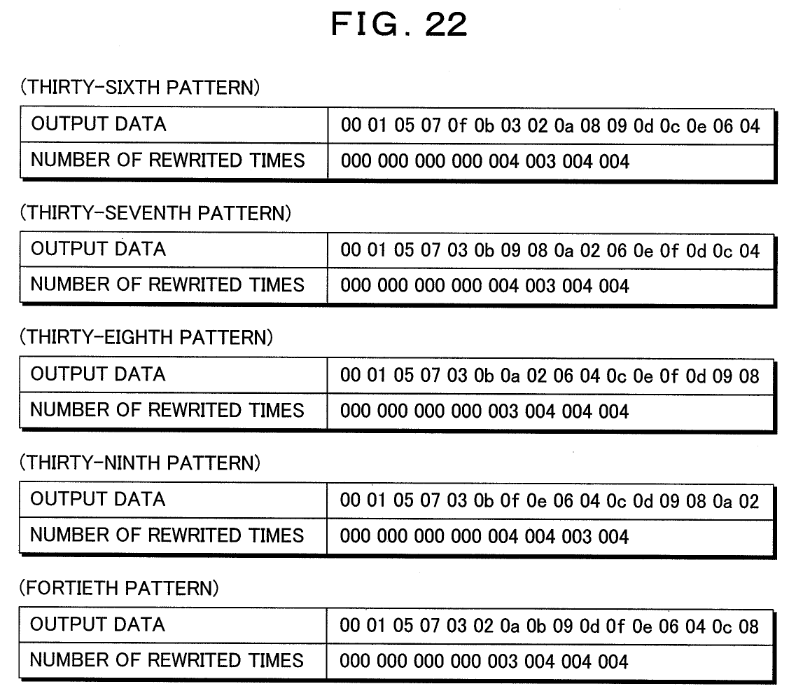

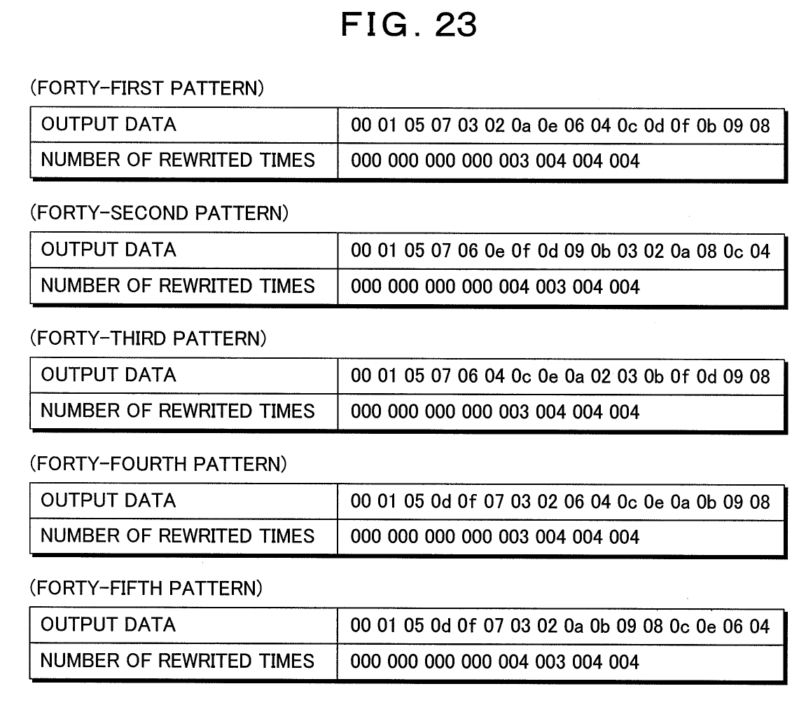

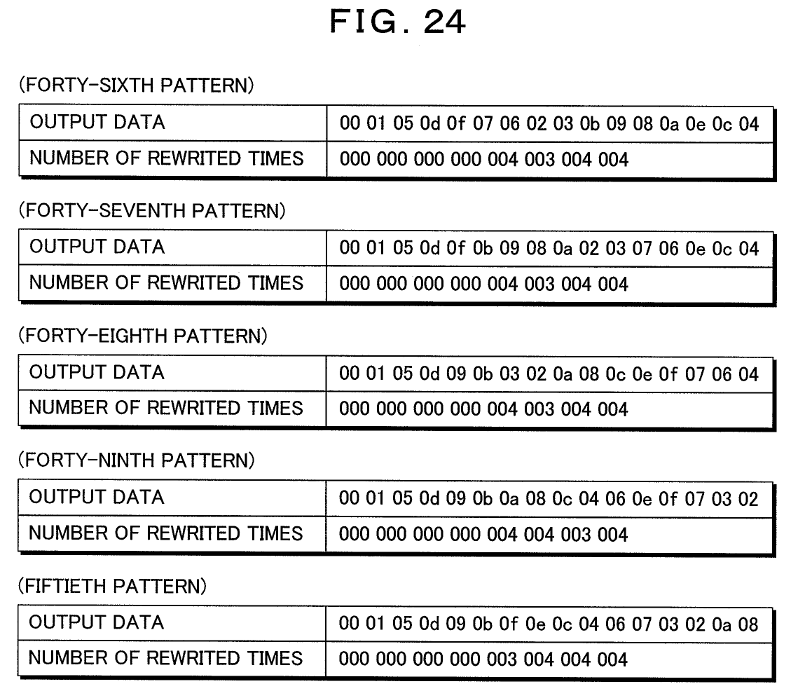

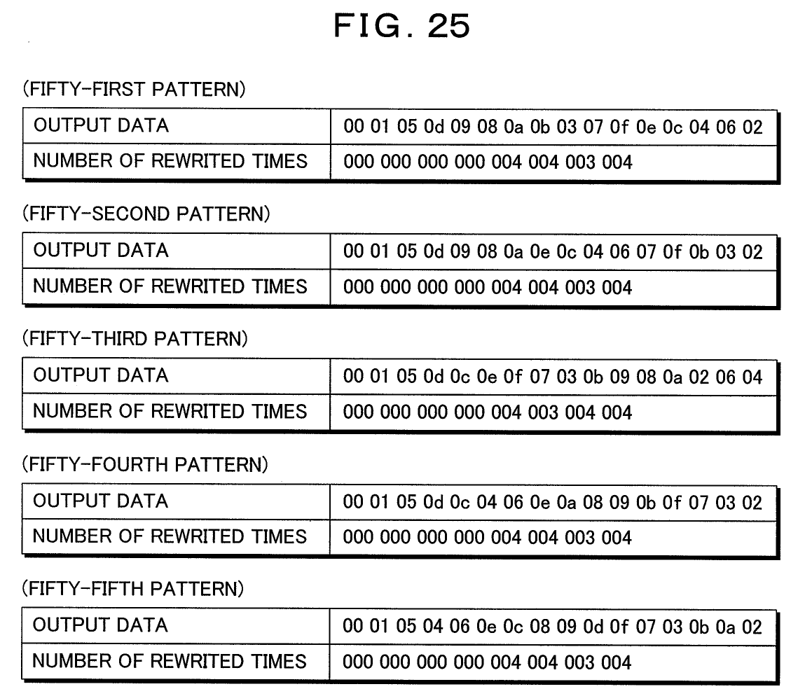

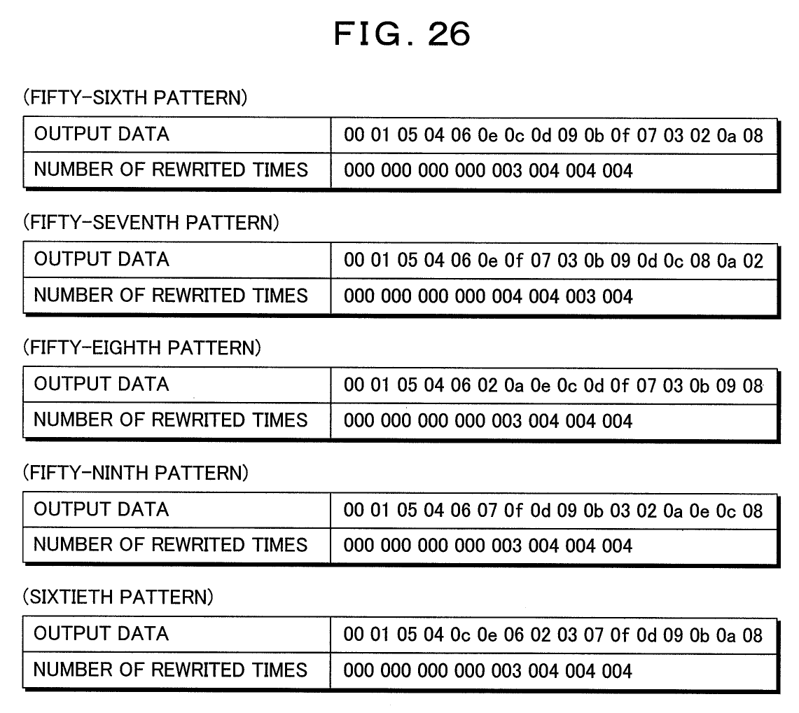

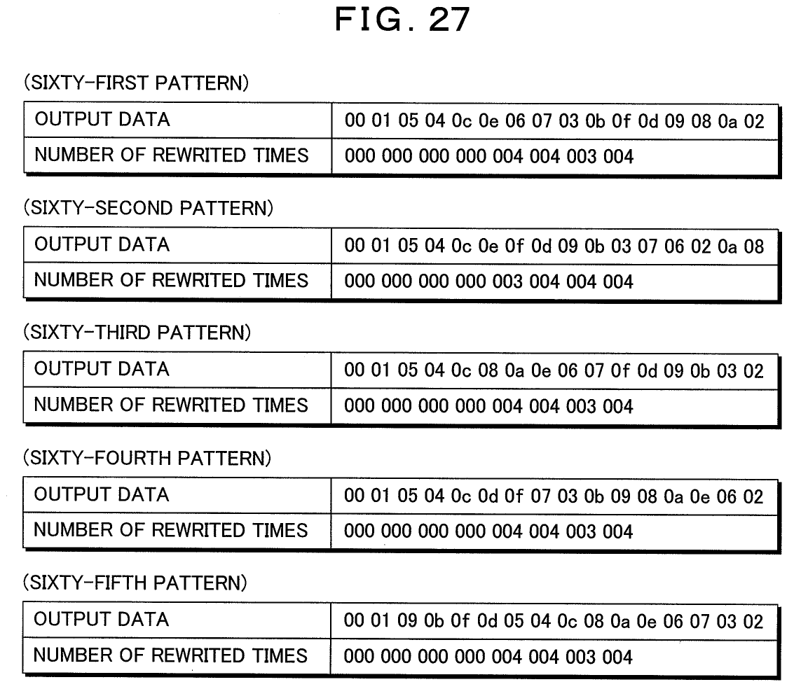

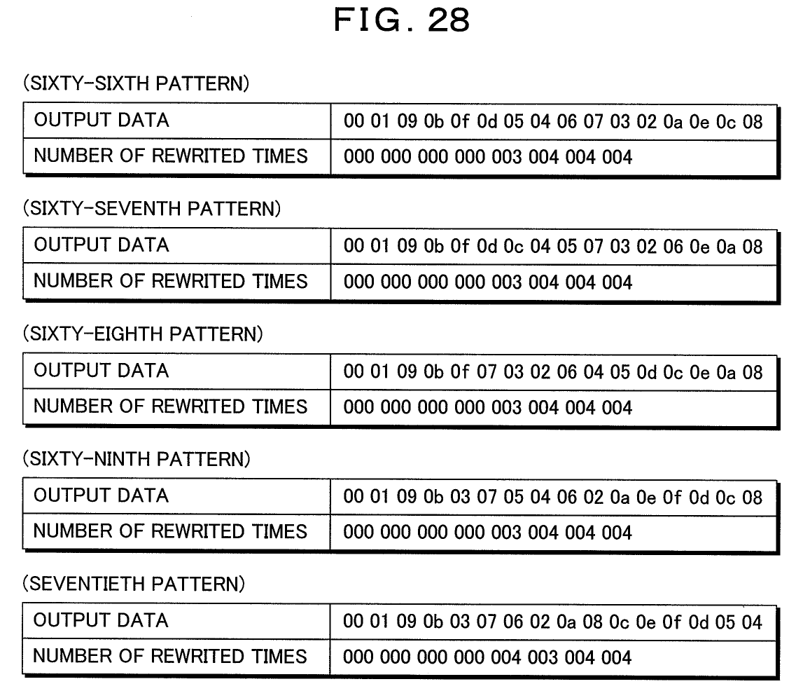

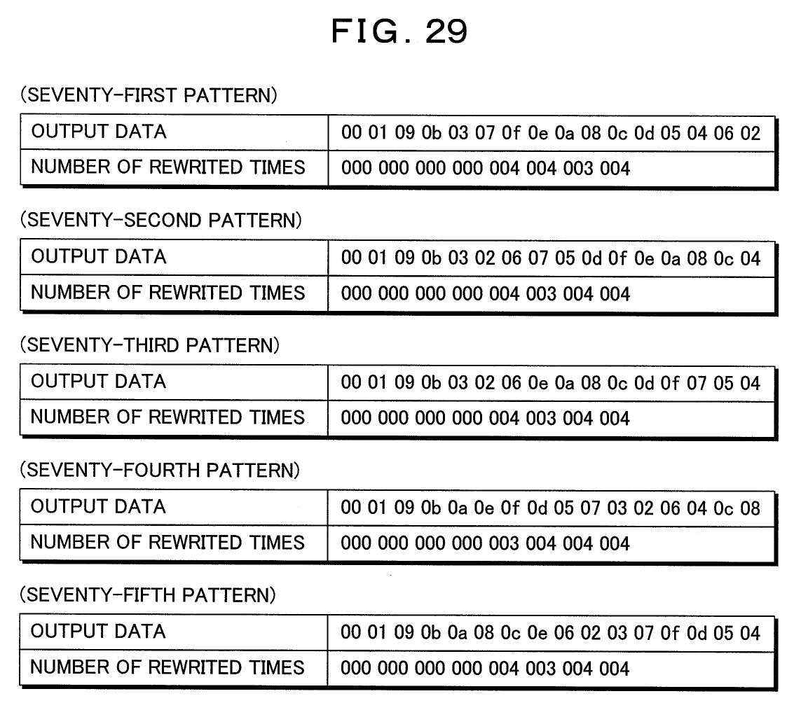

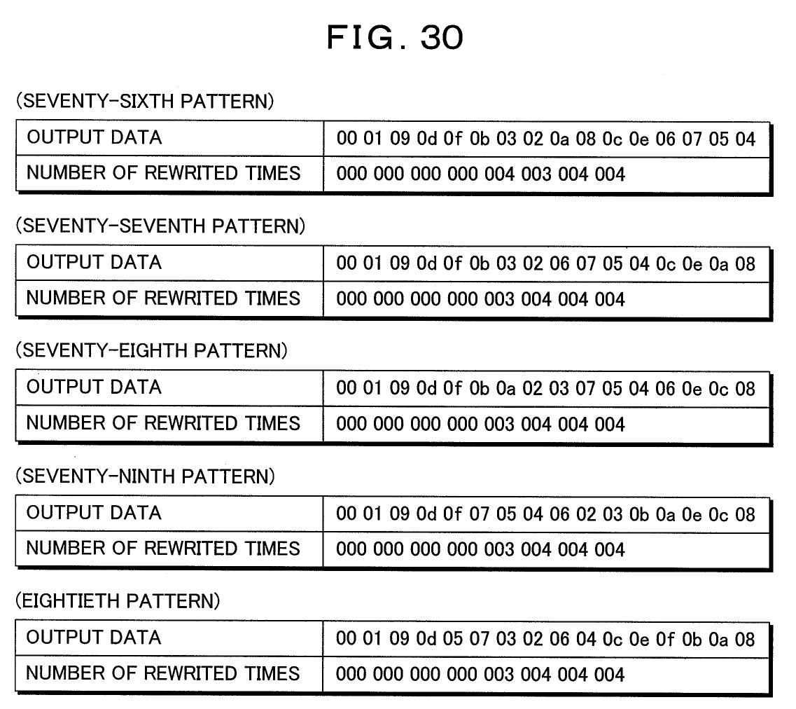

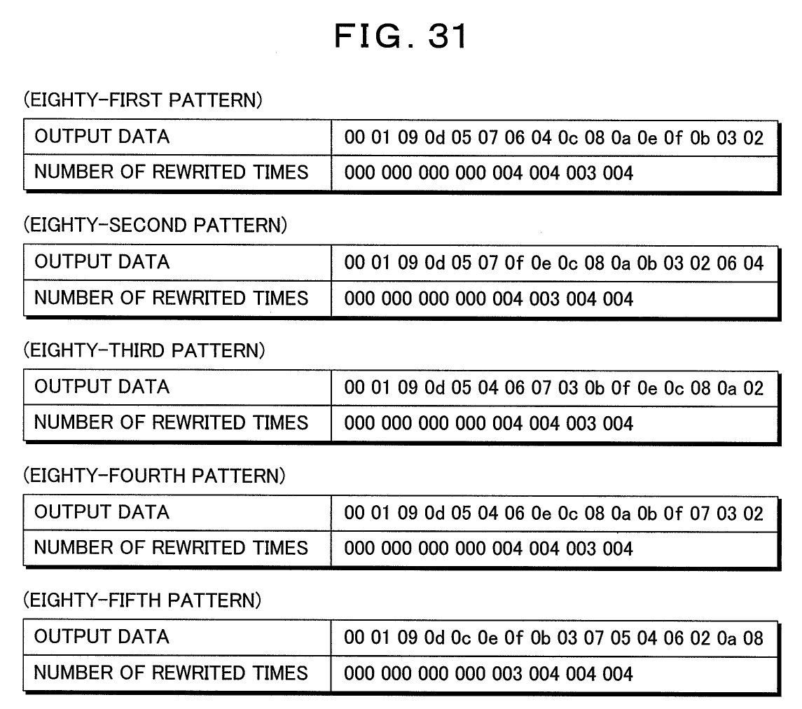

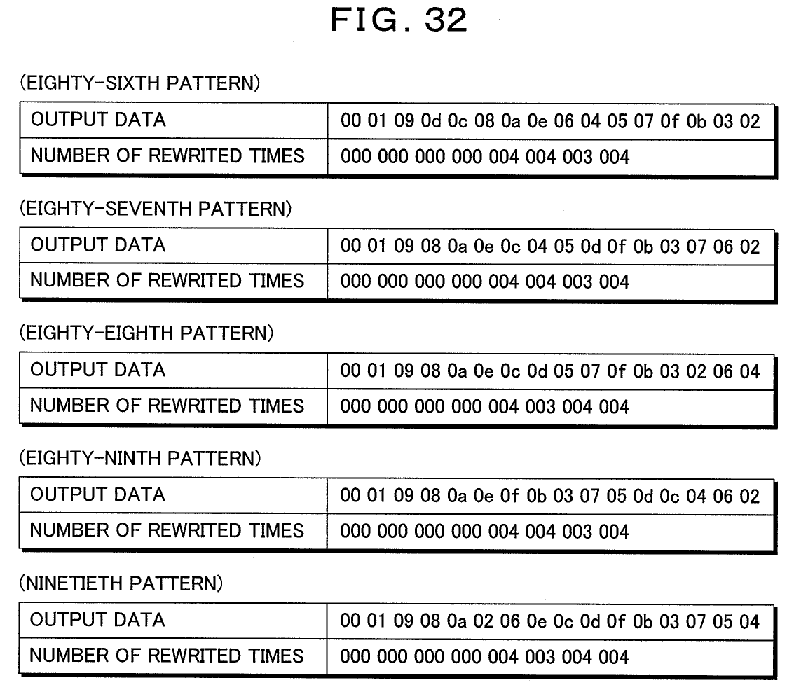

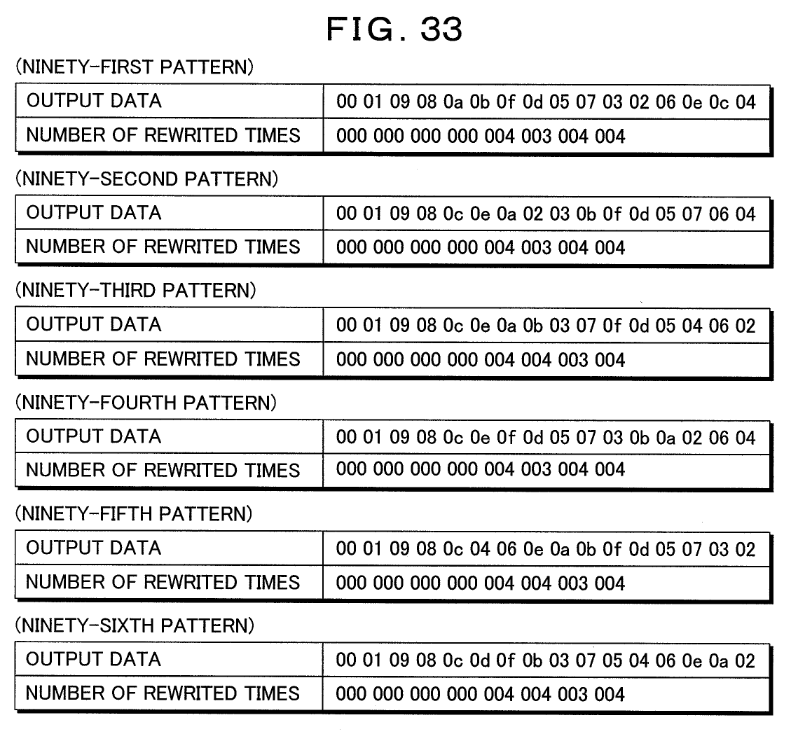

FIG. 15 to FIG. 33 show, in the manner similar to the case of FIG. 12, the output data and the number of times of rewriting of 1st to 96th patterns serving as all of the ideal 4-bit conversion tables extracted in step S5 of FIG. 13.

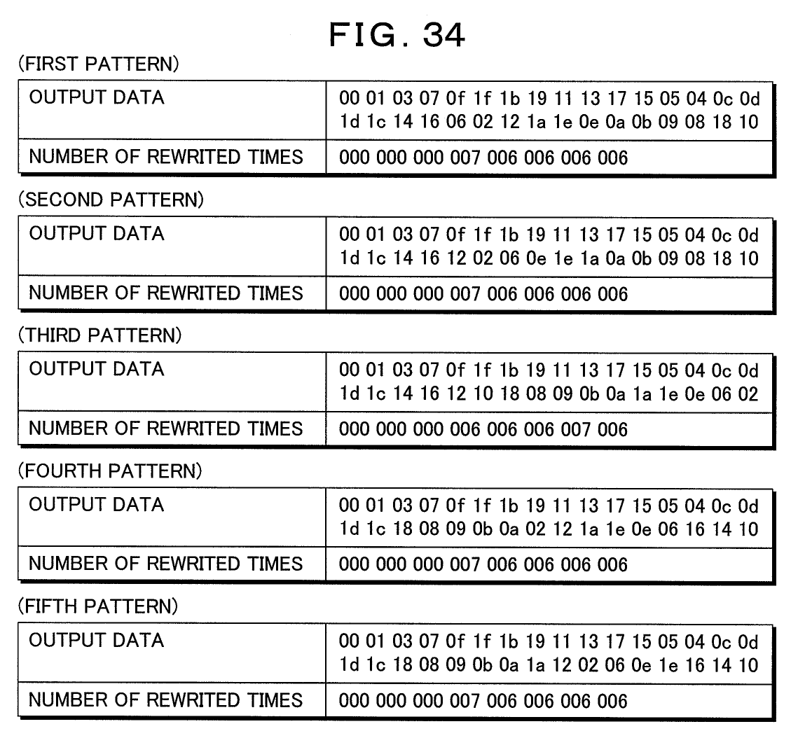

FIG. 34 shows the output data and the numbers of times of rewriting at respective bit positions of first to fifth patterns serving as part of 5-bit conversion tables of the present embodiment. In the case of the 5-bit conversion table, since counting operations are 0 to 31 in decimal, the output data has, for example, as shown in the first pattern, 32 patterns, “00, 01, 03 . . . 10”, in hexadecimal display. Also in the 5-bit conversion tables, the last output data is any of 01, 02, 04, and 08 in hexadecimal display.

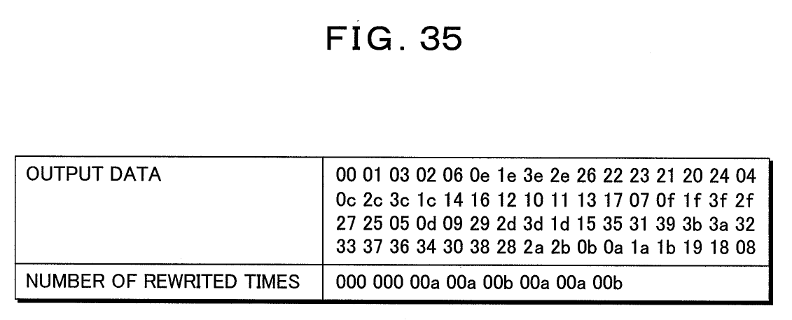

FIG. 35 shows the output data and the numbers of times of rewriting at respective bit positions of an example of a 6-bit conversion table of the present embodiment. In the case of the 6-bit conversion table, since counting operations are 0 to 63 in decimal, the output data has 64 patterns, “00, 01, 03 . . . 08”, in hexadecimal display. Also in the 6-bit conversion table, the last output data is any of 01, 02, 04, and 08, in hexadecimal display.

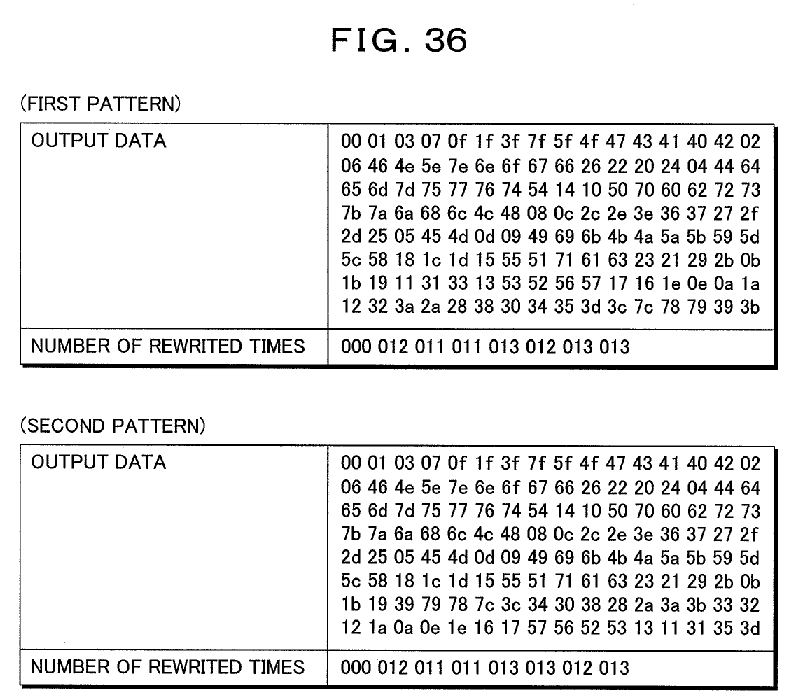

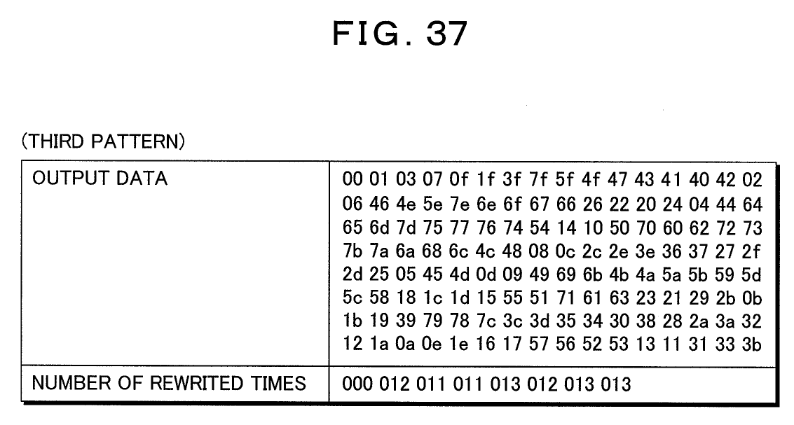

FIG. 36 and FIG. 37 show the output data and the numbers of times of rewriting at respective bit positions of 1st to 3rd patterns serving as part of 7-bit conversion tables of the present embodiment. In the case of the 7-bit conversion table, since counting operations are 0 to 255 in decimal, the output data has, for example like the first pattern of FIG. 36, 256 patterns, “00, 01, 03 . . . 3b”, in hexadecimal display.

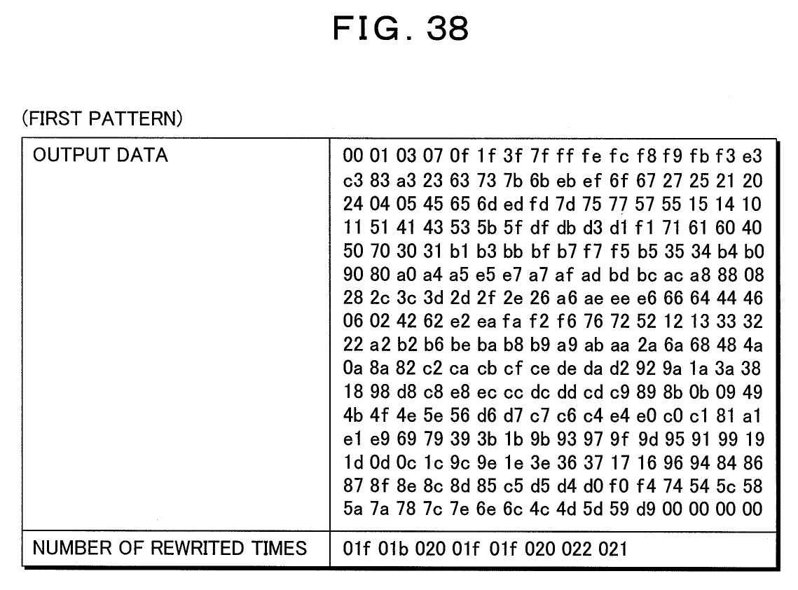

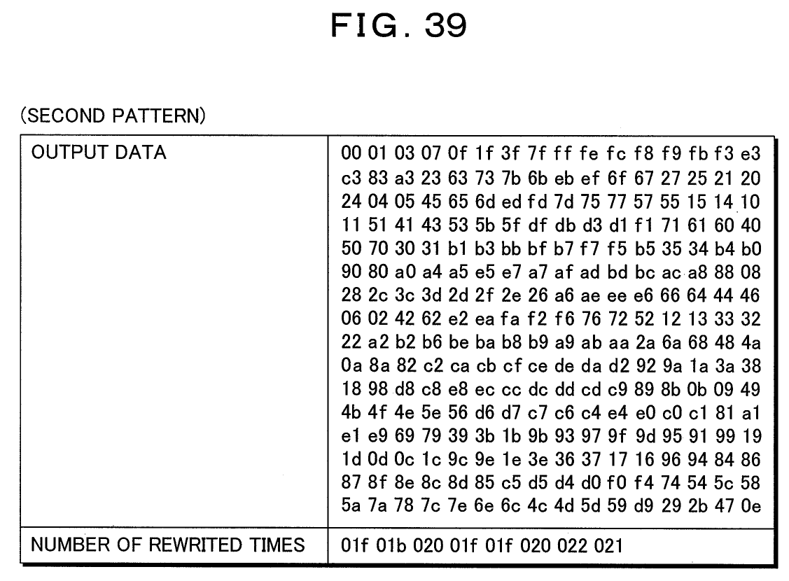

FIG. 38 and FIG. 39 show the output data and the numbers of times of rewriting at respective bit positions of 1st to 2nd patterns serving as part of 8-bit conversion tables of the present embodiment. In the case of the 8-bit conversion table, since counting operations are 0 to 511 in decimal, the output data has, for example like the first pattern of FIG. 38, 512 patterns, “00, 01, 03 . . . 00”, in hexadecimal display.

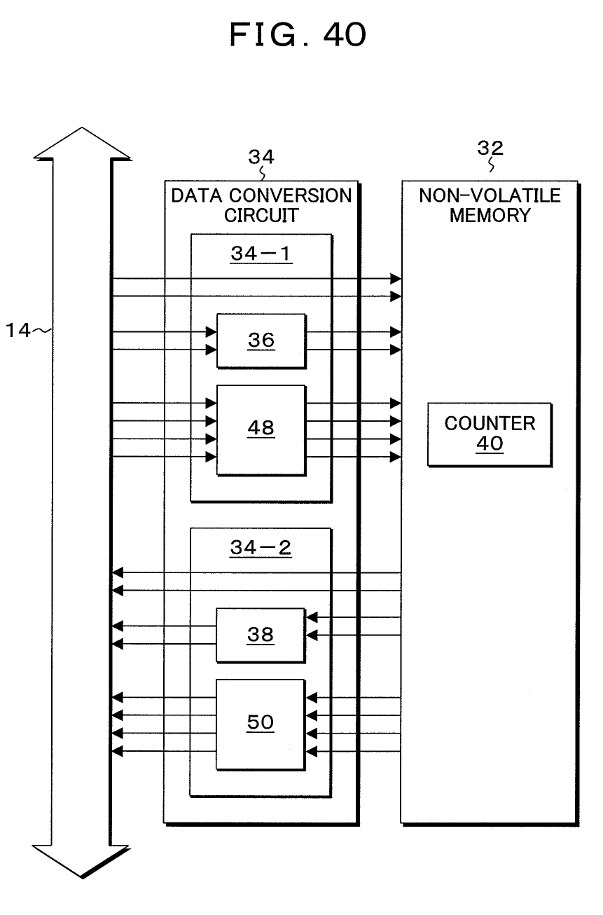

FIG. 40 is a block diagram showing another embodiment in which conversion tables and reverse conversion tables having different bit widths are combined.

In FIG. 40, in the data conversion unit 34-1 of the data conversion circuit 34, the 4-bit conversion table 48 and the 2-bit conversion table 36 are provided, lower 4 bits b0 to b3 of the write data from the bus 14 are converted by the 4-bit conversion table 48, the upper 2 bits b4 and b5 are converted at the same time by the 2-bit conversion table 36, and the upper 2 bits b6 and b7 are let pass through without converting them. Meanwhile, in the data reverse conversion unit 34-2, the 4-bit reverse conversion table 50 and the 2-bit reverse conversion table 38 are provided, lower 4 bits b0 to b3 of the data read from the non-volatile memory 32 is returned to the original state by the 4-bit reverse conversion table 50, the upper 2 bits b4 and b5 are returned to the original state at the same time by the 2-bit reverse conversion table 38, and the upper 2 bits b6 and b7 are let pass through and output to the bus 14. The 2-bit conversion table 36 and the 2-bit reverse conversion table 38 have the conversion patterns shown in FIGS. 5A and 5B. Also, the 4-bit conversion table 48 and the 4-bit reverse conversion table 50 have, for example, the conversion patterns shown in FIG. 12.

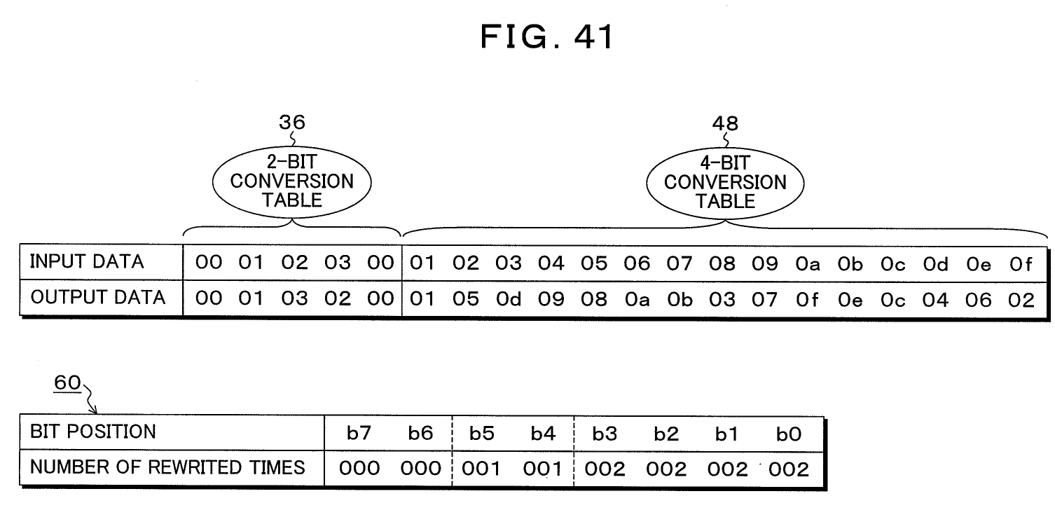

FIG. 41 shows a composite conversion table formed by the combination of the 4-bit conversion table 48 and the 2-bit conversion table 36 of FIG. 40 and also shows a rewrite number of times table 60 showing the numbers of times of rewriting with respect to bit positions.

As shown in FIG. 40 and FIG. 41, in the present embodiment of the present invention, the data to be written to the non-volatile memory 32 can be divided in different bit widths, for example, in the 4-bit width and the 2-bit width and converted by using the conversion tables respectively for the bit widths so that the numbers of times of rewriting from bit 0 to bit 1 are approximately equal among the respective bit positions, and the number of the times of rewriting of the memory cell can be reduced so as to extend the memory life. In addition, when the conversion is performed by dividing it in the 4-bit width and the 2-bit width, the capacity of the conversion table can be reduced, for example, compared with the case in which it is divided merely by the 4-bit width, and the circuit size can be reduced. Herein, in the embodiment of FIG. 40, the upper 2 bits b7 and b6 are let pass through without conversion; however, instead of letting them pass through, they can be converted by using a 2-bit conversion table. Moreover, other than the combination of the 2-bit width and the 4-bit width, conversions of arbitrary combinations including those of the 5-bit width, the 6-bit width, the 7-bit width, and the 8-bit width shown in the above described embodiments may be performed in accordance with the bit size of write data. Note that, the above described embodiments take the cases using the 5-bit conversion tables, 6-bit conversion tables, and 7-bit conversion tables as examples; however, since the bit widths which are nth power of 2 such as the 8-bit width, 16-bit width, and 32-bit width are general as the bit widths of actual data buses, using the 2-bit conversion tables, 4-bit conversion tables, and 8-bit conversion tables corresponding to that is desired. The above described embodiments take the non-volatile memory connected to the bus of the CPU of the computer as an example; however, the embodiments can be applied without modification to a non-volatile memory used in a device having a processing function such as a CPU other than a computer, and no limitation is imposed thereon by devices or uses. The above described embodiments take the non-volatile memory as an example of a memory having the limited number of times of rewriting; however, the present embodiment can be applied without modification to memories having a limited number of times of rewriting other than the non-volatile memory so as to extend the life of the memories. This means that no memory has a finite number of times of rewriting; therefore, the present invention can be applied by considering that every memory has a limited number of times of rewriting. The present invention includes arbitrary modifications that do not impair the objects and advantages thereof and is not limited by the numerical values shown in the above described embodiments.

What is claimed is:

1. A memory access control device comprising:
a memory that has a limited number of times of rewriting;
a data conversion unit that decomposes data to be written to the memory into divided write data having a predetermined bit width and subjects each of the decomposed write data to conversion to conversion data in which the frequency of update from bit 0 to bit 1 when incrementing or decrementing is performed is approximately equal among respective bit positions; and
a data reverse conversion unit that decomposes the data read from the memory into divided read data having the predetermined bit width and subjects each of the divided read data to conversion opposite to the conversion of the data conversion unit so as to return the data to original data.

2. The memory access control device according to claim 1, wherein
the data conversion unit decomposes the data to be written to the memory into divided write data having a 2-bit width, 4-bit width, 5-bit width, 6-bit width, 7-bit width, or 8-bit width and subjects each of the divided write data to conversion to the conversion data in which the frequency of update from bit 0 to bit 1 when incrementing or decrementing is performed is approximately equal among respective bit positions; and
the data reverse conversion unit decomposes the data read from the memory into divided read data having the 2-bit width, 4-bit width, 5-bit width, 6-bit width, 7-bit width, or 8-bit width and subjects each of the divided read data to the conversion opposite to the conversion of the data conversion unit to return the data to the original data.

3. The memory access control device according to claim 2, wherein
the data conversion unit converts the divided write data having 1 at all bits in binary display and having the predetermined bit width (1111 . . . 1) to data having bit 1 at an arbitrary bit position and bit 0 at all the other bit positions.

4. The memory access control device according to claim 3, wherein
the data conversion unit converts a bit sequence 11 having the 2-bit width to a bit sequence 01 or 10,
converts a bit sequence 1111 having the 4-bit width to a bit sequence 0001, 0010, 0100, or 1000,
converts a bit sequence 11111 having the 5-bit width to a bit sequence 00001, 00010, 00100, 01000, or 10000,
converts a bit sequence 111111 having the 6-bit width to a bit sequence 000001, 000010, 000100, 001000, 010000, or 100000,
converts a bit sequence 1111111 having the 7-bit width to a bit sequence 0000001, 0000010, 0000100, 0001000, 0010000, 0100000, or 1000000, and
converts a bit sequence 11111111 having the 8-bit width to a bit sequence 00000001, 00000010, 00000100, 00001000, 00010000, 00100000, 01000000, or 10000000.

5. The memory access control device according to claim 2, wherein
the data conversion unit decomposes the data to be written to the memory into the divided write data having the 2-bit width and subjects the divided write data to conversion so that
bit sequences before the conversion are 00, 01, 10, 11 and
bit sequences after the conversion are 00, 01, 11, 10
in binary display; and
the data reverse conversion unit decomposes the data read from the memory into the divided read data having the 2-bit width and subjects the divided read data to reverse conversion so that
bit sequences before the reverse conversion are 00, 01, 11, 10 and
bit sequences after the reverse conversion are 00, 01, 10, 11
in binary display.

6. The memory access control device according to claim 2, wherein
the data conversion unit decomposes the data to be written to the memory into the divided write data having the 2-bit width and subjects the divided write data to conversion so that
bit sequences before the conversion are 00, 01, 10, 11 and
bit sequences after the conversion are 00, 10, 11, 01
in binary display; and
the data reverse conversion unit decomposes the data read from the memory into the divided read data having the 2-bit width and subjects the divided read data to reverse conversion so that
bit sequences before the reverse conversion are 00, 10, 11, 01 and
bit sequences after the reverse conversion are 00, 01, 10, 11
in binary display.

7. The memory access control device according to claim 1, wherein the data conversion unit and the data reverse conversion unit are provided in the memory.

8. A memory access control method of a memory having a limited number of times of rewriting, comprising:
a data conversion step that decomposes data to be written to the memory into divided write data having a predetermined bit width and subjects each of the decomposed write data to conversion to conversion data in which the frequency of update from bit 0 to bit 1 when incrementing or decrementing is performed is approximately equal among respective bit positions; and
a data reverse conversion step that decomposes the data read from the memory into divided read data having the predetermined bit width and subjects each of the divided read data to conversion opposite to the conversion of the data conversion step so as to return the data to original data.

9. The memory access control method according to claim 8, wherein
in the data conversion step, the data to be written to the memory is decomposed into divided write data having a 2-bit width, 4-bit width, 5-bit width, 6-bit width, 7-bit width, or 8-bit width, and each of the divided write data is subjected to conversion to the conversion data in which the frequency of update from bit 0 to bit 1 when incrementing or decrementing is performed is approximately equal among respective bit positions; and,
in the data reverse conversion step, the data read from the memory is decomposed into divided read data having the 2-bit width, 4-bit width, 5-bit width, 6-bit width, 7-bit width, or 8-bit width, and each of the divided read data is subjected to the conversion opposite to the conversion of the data conversion step so as to return the data to the original data.

10. The memory access control method according to claim 9, wherein
in the data conversion step, the divided write data having 1 at all bits in binary display and having the predetermined bit width is converted to data having bit 1 at an arbitrary bit position and bit 0 at all the other bit positions.

11. The memory access control method according to claim 10, wherein
in the data conversion step,
a bit sequence 11 having the 2-bit width is converted to a bit sequence 01 or 10,
a bit sequence 1111 having the 4-bit width is converted to a bit sequence 0001, 0010, 0100, or 1000,
a bit sequence 11111 having the 5-bit width is converted to a bit sequence 00001, 00010, 00100, 01000, or 10000,
a bit sequence 111111 having the 6-bit width is converted to a bit sequence 000001, 000010, 000100, 001000, 010000, or 100000,
a bit sequence 1111111 having the 7-bit width is converted to a bit sequence 0000001, 0000010, 0000100, 0001000, 0010000, 0100000, or 1000000, and
a bit sequence 11111111 having the 8-bit width is converted to a bit sequence 00000001, 00000010, 00000100, 00001000, 00010000, 00100000, 01000000, or 10000000.

12. The memory access control method according to claim 9, wherein
in the data conversion step, the data to be written to the memory is decomposed into the divided write data having the 2-bit width, and the divided write data is subjected to conversion so that
bit sequences before the conversion are 00, 01, 10, 11 and
bit sequences after the conversion are 00, 01, 11, 10
in binary display; and,
in the data reverse conversion step, the data read from the memory is decomposed into the divided read data having the 2-bit width, and the divided read data is subjected to reverse conversion so that
bit sequences before the reverse conversion are 00, 01, 11, 10 and
bit sequences after the reverse conversion are 00, 01, 10, 11
in binary display.

13. The memory access control method according to claim 9, wherein
in the data conversion step, the data to be written to the memory is decomposed into the divided write data having the 2-bit width, and the divided write data is subjected to conversion so that
bit sequences before the conversion are 00, 01, 10, 11 and
bit sequences after the conversion are 00, 10, 11, 01
in binary display; and,
in the data reverse conversion step, the data read from the memory is decomposed into the divided read data having the 2-bit width, and the divided read data is subjected to reverse conversion so that
bit sequences before the reverse conversion are 00, 10, 11, 01 and
bit sequences after the reverse conversion are 00, 01, 10, 11
in binary display.

14. The memory access control method according to claim 9, wherein
in the data conversion step, the data to be written to the memory is decomposed into the divided write data having the 4-bit width, and the divided write data is subjected to conversion so that
bit sequences before the conversion are 0, 1, 2, 3, 4, 5, 6, 7, 8, 9, a, b, c, d, e, f and
bit sequences after the conversion are 0, 1, 5, d, 9, 8, a, b, 3, 7, f, e, c, 4, 6, 2
in hexadecimal display; and,
in the data reverse conversion step, the data read from the memory is decomposed into the divided read data having the 2-bit width, and the divided read data is subjected to reverse conversion so that
bit sequences before the reverse conversion are 0, 1, 5, d, 9, 8, a, b, 3, 7, f, e, c, 4, 6, 2 and
bit sequences after the reverse conversion are 0, 1, 2, 3, 4, 5, 6, 7, 8, 9, a, b, c, d, e, f
in hexadecimal display.

15. A computer-readable storage medium which stores a program allowing a computer to execute
a data conversion step that decomposes data to be written to a memory, which is disposed in a computer and has a limited number of times of rewriting, into divided write data having a predetermined bit width and subjects each of the decomposed write data to conversion to conversion data in which the frequency of update from bit 0 to bit 1 when incrementing or decrementing is performed is approximately equal among respective bit positions; and
a data reverse conversion step that decomposes the data read from the memory into divided read data having the predetermined bit width and subjects each of the divided read data to conversion opposite to the conversion of the data conversion step so as to return the data to original data.

16. The storage medium according to claim 15, wherein
in the data conversion step, the data to be written to the memory is decomposed into divided write data having a 2-bit width, 4-bit width, 5-bit width, 6-bit width, 7-bit width, or 8-bit width, and each of the divided write data is subjected to conversion to the conversion data in which the frequency of update from bit 0 to bit 1 when incrementing or decrementing is performed is approximately equal among respective bit positions; and,
in the data reverse conversion step, the data read from the memory is decomposed into divided read data having the 2-bit width, 4-bit width, 5-bit width, 6-bit width, 7-bit width, or 8-bit width, and each of the divided read data is subjected to the conversion opposite to the conversion of the data conversion step so as to return the data to the original data.

17. The storage medium according to claim 16, wherein
in the data conversion step, the divided write data having 1 at all bits in binary display and having the predetermined bit width is converted to data having bit 1 at an arbitrary bit position and bit 0 at all the other bit positions.

18. The storage medium according to claim 17, wherein
in the data conversion step,
a bit sequence 11 having the 2-bit width is converted to a bit sequence 01 or 10,
a bit sequence 1111 having the 4-bit width is converted to a bit sequence 0001, 0010, 0100, or 1000,
a bit sequence 11111 having the 5-bit width is converted to a bit sequence 00001, 00010, 00100, 01000, or 10000,
a bit sequence 111111 having the 6-bit width is converted to a bit sequence 000001, 000010, 000100, 001000, 010000, or 100000,
a bit sequence 1111111 having the 7-bit width is converted to a bit sequence 0000001, 0000010, 0000100, 0001000, 0010000, 0100000, or 1000000, and
a bit sequence 11111111 having the 8-bit width is converted to a bit sequence 00000001, 00000010, 00000100, 00001000, 00010000, 00100000, 01000000, or 10000000.

19. The storage medium according to claim 16, wherein
in the data conversion step, the data to be written to the memory is decomposed into the divided write data having the 2-bit width, and the divided write data is subjected to conversion so that
bit sequences before the conversion are 00, 01, 10, 11 and
bit sequences after the conversion are 00, 01, 11, 10
in binary display; and,
in the data reverse conversion step, the data read from the memory is decomposed into the divided read data having the 2-bit width, and the divided read data is subjected to reverse conversion so that
bit sequences before the reverse conversion are 00, 01, 11, 10 and
bit sequences after the reverse conversion are 00, 01, 10, 11
in binary display.

20. The storage medium according to claim 16, wherein
in the data conversion step, the data to be written to the memory is decomposed into the divided write data having the 4-bit width, and the divided write data is subjected to conversion so that
bit sequences before the conversion are 0, 1, 2, 3, 4, 5, 6, 7, 8, 9, a, b, c, d, e, f and
bit sequences after the conversion are 0, 1, 5, d, 9, 8, a, b, 3, 7, f, e, c, 4, 6, 2
in hexadecimal display; and,
in the data reverse conversion step, the data read from the memory is decomposed into the divided read data having the 2-bit width, and the divided read data is subjected to reverse conversion so that
bit sequences before the reverse conversion are 0, 1, 5, d, 9, 8, a, b, 3, 7, f, e, c, 4, 6, 2 and
bit sequences after the reverse conversion are 0, 1, 2, 3, 4, 5, 6, 7, 8, 9, a, b, c, d, e, f
in hexadecimal display.
